(19) United States
(12) Patent Application Publication
(10) Pub. No.: US 2015/0134400 A1
(43) Pub. Date: May 14, 2015

(54) MAINTENANCE PARTS INVENTORY PLANNING SYSTEM, MAINTENANCE PARTS INVENTORY PLANNING SYSTEM SERVER, AND MAINTENANCE PARTS INVENTORY PLANNING SYSTEM CLIENT TERMINAL

(71) Applicant: Satoshi Kashi, Tokyo (JP)

(72) Inventor: Satoshi Kashi, Tokyo (JP)

(21) Appl. No.: 14/406,260

(22) PCT Filed: Jun. 13, 2012
(86) PCT No.: PCT/JP2012/065121

§ 371 Date: Dec. 8, 2014

(51) Int. Cl. G06Q 10/08; G06Q 10/06; G06Q 10/00

(52) U.S. Cl. CPC G06Q 10/087; G06Q 10/20; G06Q 10/0635
USPC 705/7.28; 705/28

(57) ABSTRACT

A maintenance parts inventory planning system which creates a maintenance parts inventory planning of one or more industrial machines by computer (10), the system including: an input reception processing section (1000) which receives an input of information concerning an operating state of an industrial machine, a failure probability of a component, and operating criteria indicating conditions at two points of time, a point of time of part allocation and a point of time of part replacement of a stored part; storing sections (1600-2300) which store information input from the input reception processing section; and plan generation sections (1100-1400) which calculate a failure risk on the basis of the operating state of the industrial machine and the failure probability of the component that are stored in the storing sections, store this calculated failure risk in the storing sections, generate a maintenance parts inventory planning indicating a time-series change in an inventory quantity of maintenance parts, for which a part replacement amount is subtracted from a part allocation amount of maintenance parts so as to fulfill the operating criteria stored in the storing sections and indicating conditions at the two points of time, the point of time of part allocation and the point of time of part replacement of the stored part, and store this generated maintenance parts inventory planning in the storing sections.

### TECHNICAL FIELD OF THE INVENTION

The present invention relates to a maintenance parts inventory planning system, and particularly relates to a stand-alone type maintenance parts inventory planning system, and further relates to a technique that is applied to and effective for a client-server type maintenance parts inventory planning system server and a maintenance parts inventory planning system client terminal.

### BACKGROUND OF THE INVENTION

In existing maintenance of an industrial machine, pre-maintenance for preventing a failure from occurring is considered to be important, and an approach by which a part is replaced at a predetermined period and an approach by which a sign of a failure is detected, and then a part is replaced are taken place. In the former approach in which the period of part replacement is predetermined, it is relatively easy to make a parts inventory planning, however, in the latter approach in which a part is replaced in accordance with a sign appearing at various timings, it has not been easy to make a parts inventory planning.

Accordingly, techniques such as those of, for example, Japanese Patent No. 4416306 (Patent Document 1) and Japanese Patent No. 4237610 (Patent Document 2) are suggested. The Patent Document 1 discloses a technique for generating recommended information of pre-maintenance in such a manner that a period at which a failure risk of individual part becomes a predetermined value is regarded as a period for replacing the individual part. In addition, the Patent Document 2 discloses a technique for calculating an optimal cycle of maintenance of a device.

### PRIOR ART DOCUMENTS

### Patent Documents

Patent Document 1: Japanese Patent No. 4416306

Patent Document 2: Japanese Patent No. 4237610

### SUMMARY OF THE INVENTION

### Problems to be Solved by the Invention

In the meantime, in the aforementioned conventional maintenance of an industrial machine, it is necessary to perform appropriate pre-maintenance for the industrial machine, thereby enhancing the reliability of the industrial machine.

For example, in the system of the aforementioned Patent Document 1, even if part replacement is attempted at a period for a predetermined failure risk, if a parts inventory is not reserved, the part replacement would fail. In addition, also in the system of the aforementioned Patent Document 2, even if part replacement is attempted at an optimal cycle of maintenance of a device, if a parts inventory is not reserved, the part replacement would fail. As stated above, in the conventional techniques, a plan had to be made including the reservation of parts inventory; otherwise practicability of pre-maintenance was not sufficient.

In particular, if inventories of a part that is special and cannot be alternated and a part having a long procurement lead time were not adequate and resulted in stockout, a failure continued remaining unable to replace a part, which could have had a significant impact on an operating rate of a machine. On the contrary, it was difficult in terms of cost and cash flow to always hold, in a sufficient quantity, an expensive part that may not be used and a part that takes a lot of space.

Accordingly, the present invention is made in view of the problems of such conventional techniques, the main purpose thereof is to provide a maintenance parts inventory planning system that creates a maintenance parts inventory planning having reasonableness, in which there is no stockout or overstock of a maintenance part, thereby improving practicability and economical efficiency of maintenance and providing a reliable industrial machine.

The above and other preferred aims and novel characteristics of the present invention will be apparent from the description of the present specification and the accompanying drawings.

### Means for Solving the Problems

The typical ones of the inventions disclosed in the present application will be briefly described as follows.

(1) A typical maintenance parts inventory planning system is a maintenance parts inventory planning system which creates a maintenance parts inventory planning of one or more industrial machines by computer, and the system has the following features.

The maintenance parts inventory planning system includes: an input reception processing section which receives an input of information concerning an operating state of an industrial machine, a failure probability of a component, operating criteria indicating conditions at two points of time, a point of time of part allocation and a point of time of part replacement of a stored part; storing sections which store information input from the input reception processing section; and plan generation sections which calculate a failure risk on the basis of the operating state of the industrial machine and the failure probability of the component that are stored in the storing sections, store this calculated failure risk in the storing sections, generate a maintenance parts inventory planning indicating a time-series change in an inventory quantity of maintenance parts, for which a part replacement amount is subtracted from a part allocation amount of maintenance parts so as to fulfill the operating criteria stored in the storing sections, that indicate the conditions at the two points of time, the point of time of part allocation and the point of time of part replacement of the stored part, and store this generated maintenance parts inventory planning in the storing sections.

(2) A typical maintenance parts inventory planning system is a maintenance parts inventory planning system server for creating a maintenance parts inventory planning of one or more industrial machines, and the system has the following features

The maintenance parts inventory planning system includes: storing sections which store information input from a client terminal that receives an input of information concerning an operating state of an industrial machine, a failure probability of a component, an inventory frame that is a theoretical inventory of a stored part and operating criteria indicating conditions at two points of time, a point of time of part allocation and a point of time of part replacement of a stored part; and plan generation sections which calculate a failure risk on the basis of the operating state of the industrial machine and the failure probability of the component, that are stored in the storing sections, store this calculated failure risk in the storing sections, generate a maintenance parts inventory planning for linking a failure risk in the order from higher failure risk to an inventory frame that is a theoretical inventory of the stored part on a one-on-one basis in time series so as to fulfill the operating criteria at the time of part allocation and at the time of part replacement of the stored part, that are stored in the storing sections, and store this generated maintenance parts inventory planning in the storing sections.

A typical maintenance parts inventory planning system client terminal is a maintenance parts inventory planning system client terminal which inputs/outputs information to/from a maintenance parts inventory planning system server that creates a maintenance parts inventory planning of one or more industrial machines, and the system has the following features.

The system includes: an input reception processing section that receives input concerning an operating state of an industrial machine, a failure probability of a component, an inventory frame that is a theoretical inventory of a stored part and operating criteria indicating conditions at two points of time, a point of time of part allocation and a point of time of part replacement of a stored part; and an output processing section that outputs information from the maintenance parts inventory planning system server, in which the maintenance parts inventory planning system server calculates a failure risk on the basis of the operating state of the industrial machine and the failure probability of the component input from the input reception processing section, and transmits, a maintenance parts inventory planning generated in such a manner that a failure risk is linked to the inventory frame that is the theoretical inventory of the stored part in the order from higher failure risk on a one-on-one basis in time series so as to fulfill the operating criteria indicating conditions at two points of time, the point of time of stored part allocation and the point of time of part replacement of the stored part, to the maintenance parts inventory planning system client terminal, and in which the output processing section outputs the maintenance parts inventory planning transmitted from the maintenance parts inventory planning system server.

### Effects of the Invention

The effects obtained by typical aspects of the present invention will be briefly described below.

That is, the main effect is to provide a maintenance parts inventory planning system that can prevent omission of preparation for a failure risk and create a maintenance parts inventory planning having reasonableness, in which there is no stockout or overstock of a maintenance part, thereby improving practicability and economical efficiency of maintenance and providing a reliable industrial machine.

### BRIEF DESCRIPTIONS OF THE DRAWINGS

FIG. 1 is a diagram illustrating one example of product, part and sign that are to be applicable targets in a maintenance parts inventory planning system of one embodiment of the present invention;

FIG. 2 is a block diagram illustrating one example of the maintenance parts inventory planning system of one embodiment of the present invention;

FIG. 3 is a block diagram illustrating one example of a stand-alone type maintenance parts inventory planning system in one embodiment of the present invention;

FIG. 4 is a block diagram illustrating one example of a client-server type maintenance parts inventory planning system server and a client terminal in one embodiment of the present invention;

FIG. 5 is a diagram illustrating one example of a data structure of a screen for a plan generation procedure control processing section in the maintenance parts inventory planning system of one embodiment of the present invention;

FIG. 6 is a diagram illustrating one example of a data structure of a machine status information storage section in the maintenance parts inventory planning system of one embodiment of the present invention;

FIG. 7 is a diagram illustrating one example of a data structure of a machine status measurement information storage section in the maintenance parts inventory planning system of one embodiment of the present invention;

FIG. 8 is a diagram illustrating one example of a data structure of a diagnostic criteria information storage section in the maintenance parts inventory planning system of one embodiment of the present invention;

FIG. 9 is a diagram illustrating one example of a data structure of a parts failure probability information storage section in the maintenance parts inventory planning system of one embodiment of the present invention;

FIG. 10 is a diagram illustrating one example of a data structure of a failure risk information storage section in the maintenance parts inventory planning system of one embodiment of the present invention;

FIG. 11 is a diagram illustrating one example of a data structure of operating criteria information storage section in the maintenance parts inventory planning system of one embodiment of the present invention;

FIG. 12 is a diagram illustrating one example of a data structure of a parts inventory frame link information storage section in the maintenance parts inventory planning system of one embodiment of the present invention;

FIG. 13 is a diagram illustrating one example of a data structure of an in-stock parts link information storage section in the maintenance parts inventory planning system of one embodiment of the present invention;

FIG. 14 is a diagram illustrating one example of a menu screen of the maintenance parts inventory planning system of one embodiment of the present invention;

FIG. 15 is a diagram illustrating one example of a screen for editing/referring to the machine status information in the maintenance parts inventory planning system of one embodiment of the present invention;

FIG. 16 is a diagram illustrating one example of a screen for editing/referring to the machine status measurement information in the maintenance parts inventory planning system of one embodiment of the present invention;

FIG. 17 is a diagram illustrating one example of a screen for editing/referring to the diagnostic criteria information in the maintenance parts inventory planning system of one embodiment of the present invention;

FIG. 18 is a diagram illustrating one example of a screen for editing/referring to the parts failure probability information in the maintenance parts inventory planning system of one embodiment of the present invention;

FIG. 19 is a diagram illustrating one example of a screen for referring to the failure risk information in the maintenance parts inventory planning system of one embodiment of the present invention;

FIG. 20 is a diagram illustrating one example of a screen for editing/referring to the operating criteria information in the maintenance parts inventory planning system of one embodiment of the present invention;

FIG. 21 is a diagram illustrating one example of a screen for editing/referring to the parts inventory frame link information in the maintenance parts inventory planning system of one embodiment of the present invention;

FIG. 22 is a diagram illustrating one example of a screen for editing/referring to the in-stock parts link information in the maintenance parts inventory planning system of one embodiment of the present invention;

FIG. 23 is a flowchart illustrating one example (1/2) of a processing flow relating to the plan generation procedure control processing section in the maintenance parts inventory planning system of one embodiment of the present invention;

FIG. 24 is a flowchart illustrating one example (2/2) of a processing flow relating to the plan generation procedure control processing section in the maintenance parts inventory planning system of one embodiment of the present invention;

FIG. 25 is a flowchart illustrating one example (1/2) of a processing flow relating to the failure risk diagnosis processing section in the maintenance parts inventory planning system of one embodiment of the present invention;

FIG. 26 is a flowchart illustrating one example (2/2) of a processing flow relating to the failure risk diagnosis processing section in the maintenance parts inventory planning system of one embodiment of the present invention;

FIG. 27 is a flowchart illustrating one example (1/2) of a processing flow relating to the parts inventory frame link processing section in the maintenance parts inventory planning system of one embodiment of the present invention;

FIG. 28 is a flowchart illustrating one example (2/2) of a processing flow relating to the parts inventory frame link processing section in the maintenance parts inventory planning system of one embodiment of the present invention;

FIG. 29 is a flowchart illustrating one example (1/2) of a processing flow relating to the in-stock parts link processing section in the maintenance parts inventory planning system of one embodiment of the present invention; and

FIG. 30 is a flowchart illustrating one example (2/2) of a processing flow relating to the in-stock parts link processing section in the maintenance parts inventory planning system of one embodiment of the present invention.

### DESCRIPTIONS OF THE PREFERRED EMBODIMENTS

In the embodiments described below, the invention will be described in a plurality of sections or embodiments when required as a matter of convenience. However, these sections or embodiments are not irrelevant to each other unless otherwise stated, and the one relates to the entire or a part of the other as a modification example, details, or a supplementary explanation thereof. Also, in the embodiments described below, when referring to the number of elements (including number of pieces, values, amount, range, and the like), the number of the elements is not limited to a specific number unless otherwise stated or except the case where the number is apparently limited to a specific number in principle. The number larger or smaller than the specified number is also applicable.

Further, in the embodiments described below, it goes without saying that the components (including element steps) are not always indispensable unless otherwise stated or except the case where the components are apparently indispensable in principle. Similarly, in the embodiments described below, when the shape of the components, positional relation thereof, and the like are mentioned, the substantially approximate and similar shapes and the like are included therein unless otherwise stated or except the case where it is conceivable that they are apparently excluded in principle. The same goes for the numerical value and the range described above.

### Summary of Embodiment of the Present Invention

(1) A maintenance parts inventory planning system according to an embodiment of the present invention is a maintenance parts inventory planning system which creates a maintenance parts inventory planning of one or more industrial machines by computer, and has the following features (as an example, a reference symbol of the corresponding component is additionally described in parentheses “( )”).

The aforementioned maintenance parts inventory planning system (10) has a feature of including: an input reception processing section (1000) which receives an input of information concerning an operating state of an industrial machine, a failure probability of a component and operating criteria indicating conditions at two points of time, a point of time of part allocation and a point of time of part replacement of a stored part; storing sections (1600-2300) which store information input from the aforementioned input reception processing section; and plan generation sections (1100-1400) which calculate a failure risk on the basis of the operating state of the aforementioned industrial machine and the failure probability of the aforementioned component, that are stored in the aforementioned storing sections, store this calculated failure risk in the aforementioned storing sections, generate a maintenance parts inventory planning indicating a time-series change in an inventory quantity of maintenance parts, for which the part replacement amount is subtracted from the part allocation amount of maintenance parts so as to fulfill the aforementioned operating criteria indicating conditions at two points of time, the point of time of part allocation and the point of time of part replacement of the aforementioned stored part, that are stored in the aforementioned storing sections, and store this generated maintenance parts inventory planning in the aforementioned storing sections.

(2) A maintenance parts inventory planning system server according to an embodiment of the present invention is a maintenance parts inventory planning system server which creates a maintenance parts inventory planning of one or more industrial machines, and has the following features (as an example, reference signs of corresponding components and the like are appended in parentheses).

The aforementioned maintenance parts inventory planning system server (10a) is characterized by being provided with: storing sections (1600-2300) which store information input from a client terminal that receives an input of information concerning an operating state of an industrial machine, the failure probability of a component, an inventory frame that is a theoretical inventory of a stored part and operating criteria indicating conditions at two points of time, a point of time of part allocation and a point of time of part replacement of a stored part; and plan generation sections (1100-1400) which calculate a failure risk on the basis of the operating state of the aforementioned industrial machine and the failure probability of the aforementioned component, that are stored in the aforementioned storing sections, store this calculated failure risk in the aforementioned storing sections, generate a maintenance parts inventory planning for linking a failure risk in the order from higher failure risk to an inventory frame that is the theoretical inventory of the aforementioned stored part on a one-on-one basis in time series so as to fulfill the operating criteria at the time of part allocation and at the time of part replacement of the aforementioned stored part, that are stored in the aforementioned storing sections, and store this generated maintenance parts inventory planning in the aforementioned storing sections.

(3) A maintenance parts inventory planning system client terminal according to an embodiment of the present invention is a maintenance parts inventory planning system client terminal which inputs/outputs information to/from a maintenance parts inventory planning system server that creates a maintenance parts inventory planning of one or more industrial machines, and has the following features (as an example, reference signs of corresponding components and the like are appended in parentheses).

The aforementioned maintenance parts inventory planning system client terminals (30, 40) are provided with: input reception processing sections (3100, 4100) which receive input concerning an operating state of an industrial machine, a failure probability of a component, an inventory frame that is a theoretical inventory of a stored part and operating criteria indicating conditions at two points of time, a point of time of part allocation and a point of time of part replacement of a stored part; and output processing sections (3500, 4500) which output information from the aforementioned maintenance parts inventory planning system server. Furthermore, in the aforementioned maintenance parts inventory planning system server, a failure risk is calculated on the basis of the operating state of the aforementioned industrial machine and the failure probability of the aforementioned component input from the aforementioned input reception processing section, and a maintenance parts inventory planning generated by linking a failure risk in the order from higher failure risk to an inventory frame that is the theoretical inventory of the aforementioned stored part on a one-on-one basis in time series so as to fulfill the aforementioned operating criteria indicating conditions at the two points of time, the point of time of part allocation and the point of time of part replacement of the aforementioned stored part, that are stored in the aforementioned storing sections is transmitted to the aforementioned maintenance parts inventory planning system client terminal. Furthermore, the aforementioned output processing sections are characterized in outputting the aforementioned maintenance parts inventory planning that is transmitted from the aforementioned maintenance parts inventory planning system server.

One embodiment based on the general description of an embodiment of the present invention described above will be described in details on the basis of the drawings. In addition, in all drawings for describing the embodiment, the same member is denoted by the same reference sign as a general rule and the explanation thereof will be omitted.

### One Embodiment

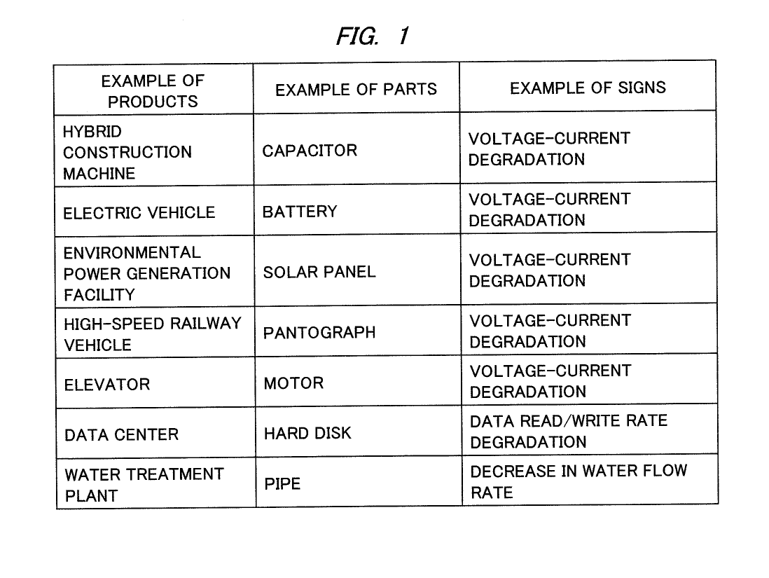

A maintenance parts inventory planning system, a maintenance parts inventory planning system server and a maintenance parts inventory planning system client terminal according to this embodiment will be described with reference to FIG. 1 to FIG. 30.

In this embodiment, an example of a maintenance parts inventory planning system which receives an input of information concerning an operating state of an industrial machine, a failure probability of a component, an inventory frame that is a theoretical inventory of a stored part, operating criteria indicating conditions at two points of time, a point of time of part allocation and a point of time of part replacement of a stored part, and an in-stock part, calculates a failure risk on the basis of the operating state of the industrial machine and the failure probability of the component, generates a maintenance parts inventory planning for linking a failure risk in the order from higher failure risk to an inventory frame that is a theoretical inventory of a stored part on a one-on-one basis in time series so as to fulfill the operating criteria indicating conditions at the two points of time, the point of time of part allocation and a point of time of part replacement of the stored part, and further generates maintenance in-stock parts planning for linking said maintenance parts inventory planning to an in-stock part will be described.

The present invention is not limited to the example of the abovementioned maintenance parts inventory planning system, and is applicable in a case where an input of information concerning an operating state of an industrial machine, a failure probability of a component, operating criteria indicating conditions at two points of time, a point of time of part allocation and a point of time of part replacement of a stored part is received, and also in a case where an input of information concerning an operating state of an industrial machine, a failure probability of a component, a inventory frame that is a theoretical inventory of a stored part, operating criteria indicating conditions at two points of time, a point of time of part allocation and a point of time of part replacement of a stored part is received within information concerning the operating state of the industrial machine, the failure probability of the component, the inventory frame that is the theoretical inventory of the stored part, operating criteria indicating conditions at two points of time, a point of time of part allocation and a point of time of part replacement of a stored part, and the in-stock part. In such a case, on the basis of the information, input of which is received, a similar processing is performed.

<One Example of Applicable Targets: Product; Part; and Sign>

The maintenance parts inventory planning system according to this embodiment generates a maintenance parts inventory planning in sign detection maintenance, and here, one example of products, parts and signs that are to be specific applicable targets, is shown in FIG. 1. It goes without saying that these applicable targets are not limited to the example shown in FIG. 1.

The maintenance parts inventory planning system according to this embodiment is intended for a part in which there is a proportional relation between an increase in a cumulative usage time of a part and a deterioration degree of a part. For example, for a part called capacitor that accumulates and releases regenerative energy of right and left turning of a hybrid construction machine, a maintenance parts inventory planning is generated so as to be able to replace a part before said capacitor breaks down by detecting a sign of a voltage-current degradation.

For example, for a part called battery that generates a driving force of an electric vehicle, a maintenance parts inventory planning is generated so as to be able to replace a part before said battery breaks down by detecting a sign of a voltage-current degradation. For example, for a part called solar panel that generates electrical energy of an environmental power generation facility, a maintenance parts inventory planning is generated so as to be able to replace a part before said solar panel breaks down by detecting a sign of a voltage-current degradation.

For example, for a part called pantograph that receives the supply of a power to be used in a high-speed railway vehicle from an overhead wire, a maintenance parts inventory planning of said pantograph is generated by detecting a sign of a voltage-current degradation. For example, for a part called motor that moves up and down an elevator car, a maintenance parts inventory planning of said motor is generated by detecting a sign of a voltage-current degradation.

For example, for a part called hard disk inside of a computer of a data center, a maintenance parts inventory planning is generated so as to replace a hard disk with one having a higher capacity before a trouble is caused on software running on said hard disk by detecting a sign of data read/write rate degradation. For example, for a part called pipe that allows the passage of pretreatment water of a water treatment plant, a maintenance parts inventory planning is generated so as to replace a part before said pipe breaks down by detecting a sign of a decrease in water flow rate.

<Maintenance Parts Inventory Planning System>

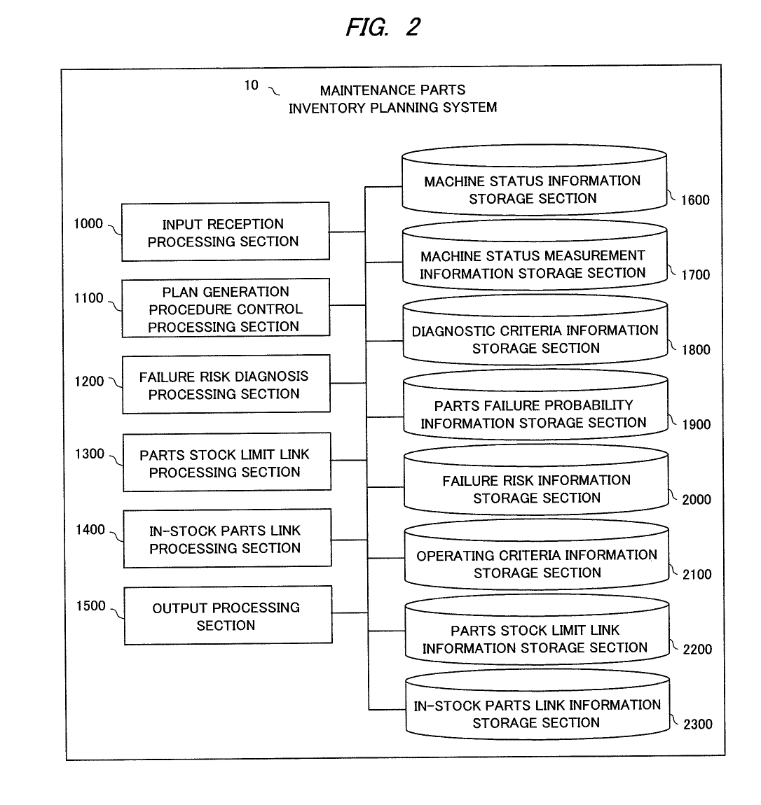

FIG. 2 is one example of a block diagram of a maintenance parts inventory planning system according to this embodiment.

Maintenance parts inventory planning system 10 comprises an input reception processing section 1000, a plan generation procedure control processing section 1100, a failure risk diagnosis processing section 1200, a parts inventory frame link processing section 1300, an in-stock parts link processing section 1400, an output processing section 1500, a machine status information storage section 1600, a machine status measurement information storage section 1700, a diagnostic criteria information storage section 1800, a parts failure probability information storage section 1900, a failure risk information storage section 2000, an operating criteria information storage section 2100, a parts inventory frame link information storage section 2200, and an in-stock parts link information storage section 2300.

The input reception processing section 1000 is a processing section which receives an input of each piece of information to each information storage section and each processing section. The plan generation procedure control processing section 1100 is a processing section which controls a movement of each processing section in order for a maintenance part planning to be generated.

The machine status information storage section 1600 is a information storage section which stores machine status information containing past performance and future possibility per calendar date of a machine cumulative operating time of a machine, a machine operating rate and a part cumulative usage time of a part used. The machine status measurement information storage section 1700 is a information storage section which stores machine status measurement information containing a past performance per calendar date of a measured value for every a measurement item relating to a condition of a part used of a machine.

The diagnostic criteria information storage section 1800 is an information storage section which stores diagnostic criteria information indicating a condition such as a measured value upper limit and a measured value lower limit and for every a measurement item relating to a condition of a part and a sign type diagnosed if said condition is not fulfilled per part cumulative usage time. The parts failure probability information storage section 1900 is an information storage section which stores parts failure probability information indicating a parts failure probability for every part relating to a sign type per part cumulative usage time.

The failure risk information storage section 2000 is an information storage section which stores information of related failure risks indicating machine status information and machine status measurement information per calendar date of a failure risk and a collection of all failure risks of a same machine and a same part, and failure risk information in which information of a sign upon discovery and of a calendar date of part replacement due date are associated with each other. The operating criteria information storage section 2100 is an information storage section which stores operating criteria information indicating when a part should be replaced and when the part should be reserved for every sign type.

The parts inventory frame link information storage section 2200 is an information storage section which stores parts inventory frame link information containing a link status of a failure risk per calendar date of a parts inventory frame for every part. The in-stock parts link information storage section 2300 is an information storage section which stores in-stock parts link information containing a link status of a parts inventory frame per calendar date of an in-stock part for every part.

The failure risk diagnosis processing section 1200 is a processing section which reads the machine status information, machine status measurement information and parts failure probability information, diagnoses failure risk, and generates failure risk information. The parts inventory frame link processing section 1300 is a processing section which reads failure risk information and operating criteria information, and generates a maintenance parts inventory planning for linking a failure risk to a parts inventory frame.

The in-stock parts link processing section 1400 is a processing section which generates a maintenance parts inventory planning for linking parts inventory frame link information to an in-stock part. The output processing section 1500 is a processing section which outputs each piece of information from each information storage section and each processing section.

<Stand-Alone Type and Client-Server Type>

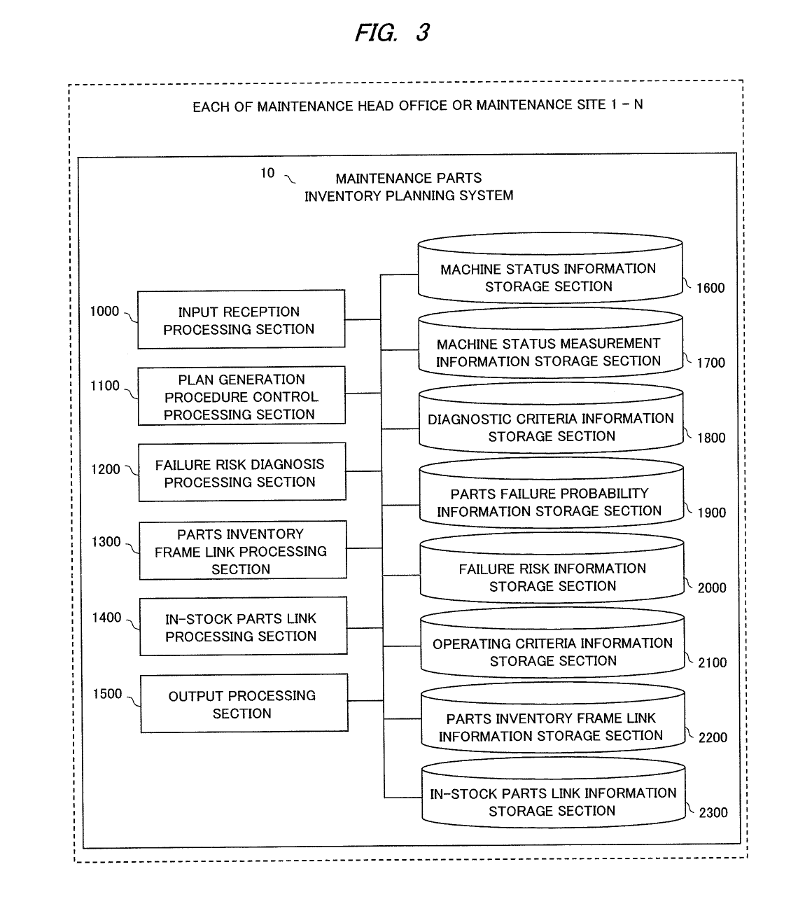

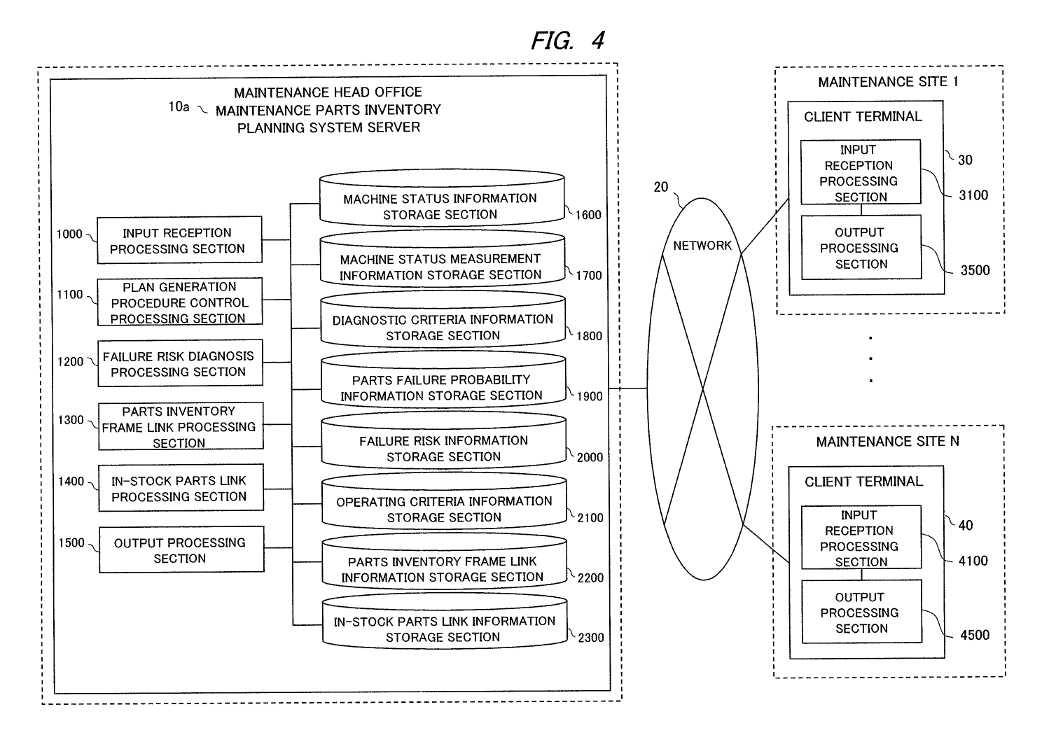

The maintenance parts inventory planning system 10 according to this embodiment may be placed in a maintenance head office and maintenance sites 1-n in various locations in a stand-alone manner and used in such a manner as one example shown in FIG. 3 (stand-alone type). In addition, in such a manner as one example shown in FIG. 4, there may be a case where maintenance parts inventory planning system server 10a is placed in a maintenance head office, and may be used from a client terminal 30(40) at not only the maintenance head office but also at the maintenance sites in various locations through a network 20 (client-server type).

In addition to this, the maintenance parts inventory planning system server 10a may be placed not at the maintenance head office, but at a specific maintenance site, and may be used from the client terminal 30(40) of other maintenance sites through the network 20. Moreover, the maintenance parts inventory planning system server 10a may be placed at a data center which is neither the maintenance head office nor the specific maintenance site, and may be used from the client terminal 30(40) in the maintenance head office and maintenance sites in various locations through the network 20.

For example, information concerning a target operating rate and an owned resource is input at the client terminal 30, a maintenance planning based on the input information is generated at the maintenance parts inventory planning system server, the generated maintenance planning is transmitted to the client terminal 30 through the network 20, and the maintenance planning is output and displayed at the client terminal 30.

<Each Data Structure of Maintenance Parts Inventory Planning System>

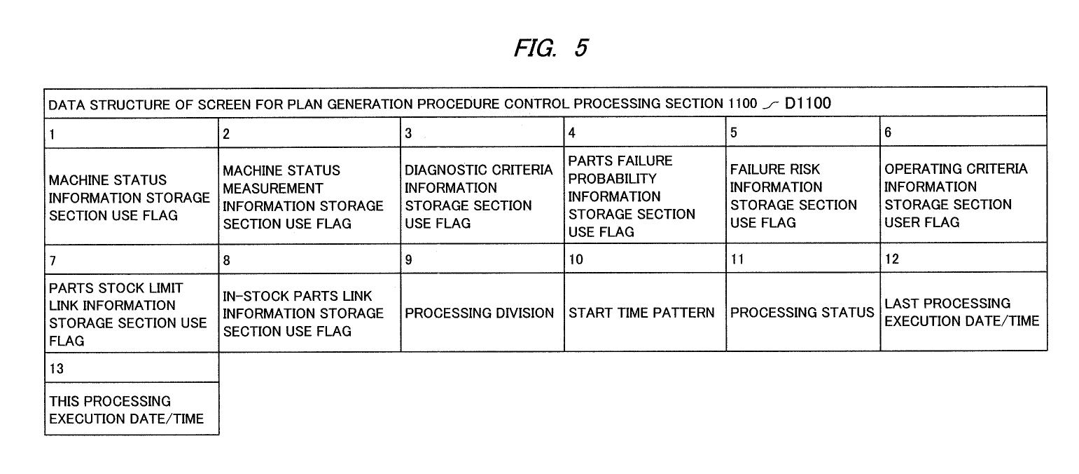

The maintenance parts inventory planning system 10 according to this embodiment has each data structure such as that shown in, for example, FIG. 5 to FIG. 13.

FIG. 5 is a data structure D1100 of a screen for a plan generation procedure control processing section 1100. This data structure D1100 contains a data item 1 (machine status information storage section use flag), a data item 2 (machine status measurement information storage section use flag), a data item 3 (diagnostic criteria information storage section use flag), a data item 4 (parts failure probability information storage section use flag), a data item 5 (failure risk information storage section use flag), a data item 6 (operating criteria information storage section use flag). The data structure D1100 further contains a data item 7 (parts inventory frame link information storage section use flag), a data item 8 (in-stock parts link information storage section use flag), a data item 9 (processing division), a data item 10 (start time pattern), a data item 11 (processing status), a data item 12 (last processing execution date/time), and a data item 13 (this processing execution date/time).

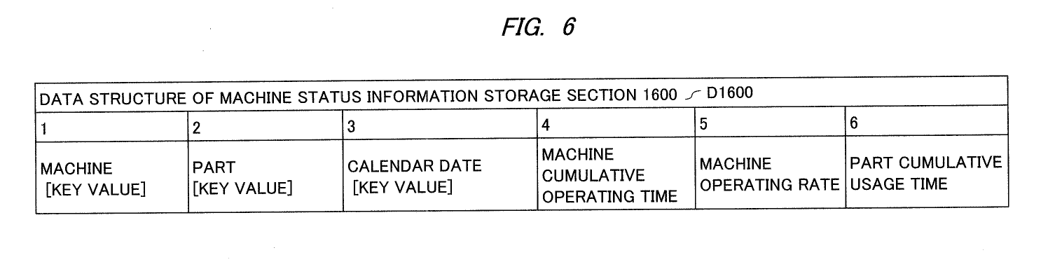

FIG. 6 is a data structure D1600 of the machine status information storage section 1600, by which a record is uniquely determined using a machine, a part and a calendar date as a key value. This data structure D1600 contains a data item 1 (machine [key value]), a data item 2 (part [key value]), a data item 3 (calendar date [key value]), a data item 4 (machine cumulative operating time), a data item 5 (machine operating rate), and a data item 6 (part cumulative usage time).

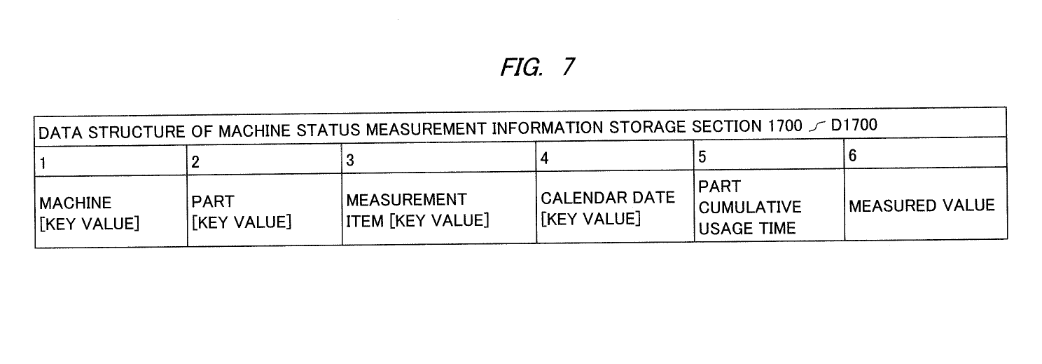

FIG. 7 is a data structure D1700 of the machine status measurement information storage section 1700, by which a record is uniquely determined using a machine, a part, a measurement item and a calendar date as a key value. This data structure D1700 contains a data item 1 (machine [key value]), a data item 2 (part [key value]), a data item 3 (measurement item [key value]), a data item 4 (calendar date [key value]), a data item 5 (part cumulative usage time), and a data item 6 (measured value).

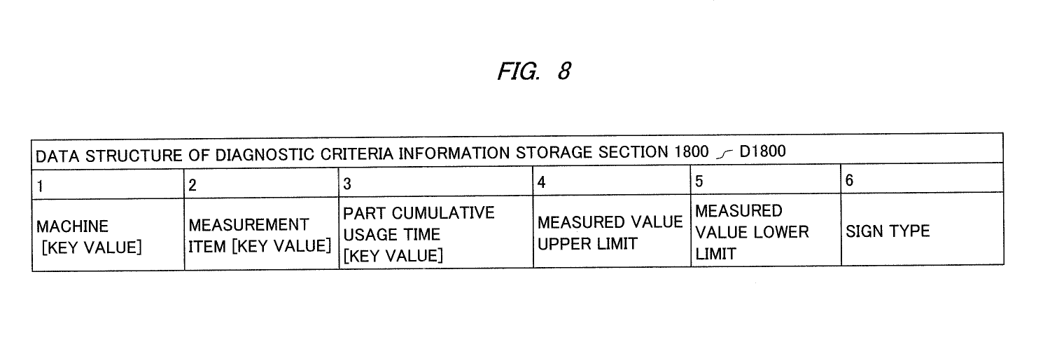

FIG. 8 is a data structure D1800 of the diagnostic criteria information storage section 1800, by which a record is uniquely determined using a part, a measurement item and a part cumulative usage time as a key value. This data structure D1800 contains a data item 1 (part [key value]), a data item 2 (measurement item [key value]), a data item 3 (part cumulative usage time [key value]), a data item 4 (measured value upper limit), a data item 5 (measured value lower limit), and a data item 6 (sign type).

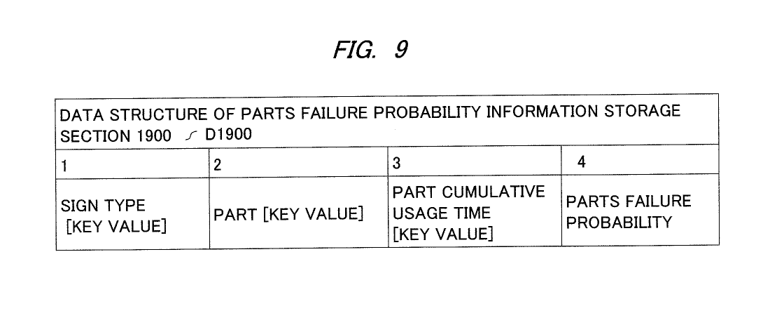

FIG. 9 is a data structure D1900 of the parts failure probability information storage section 1900, by which a record is uniquely determined using a sign type, a part and a part cumulative usage time as a key value. This data structure D1900 contains a data item 1 (sign type [ key value]), a data item 2 (part [ key value]), a data item 3 (part cumulative usage time [key value]), and a data item 4 (parts failure probability).

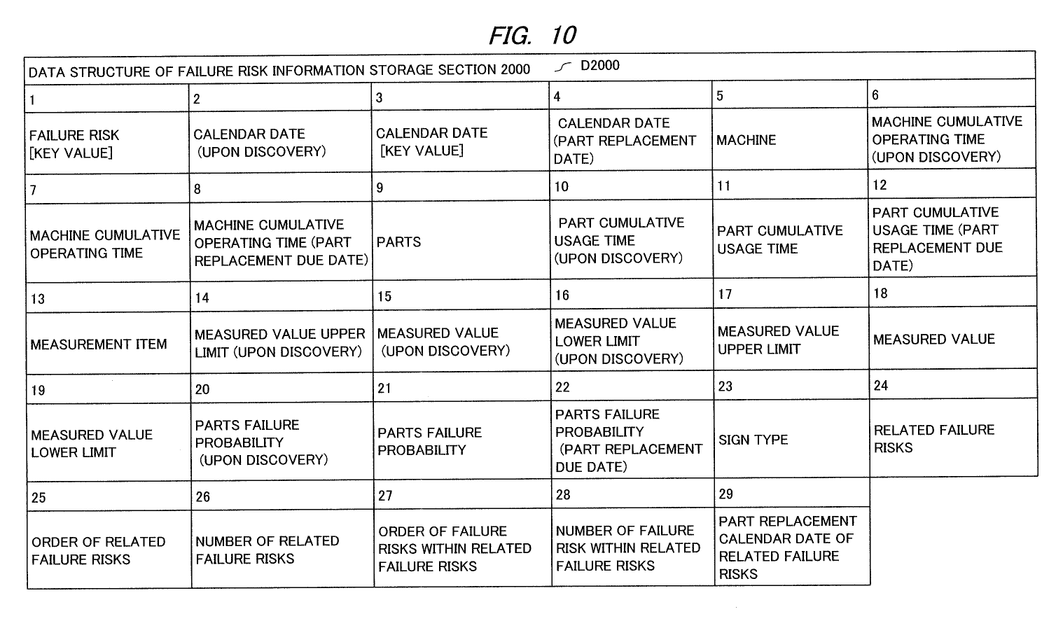

FIG. 10 is a data structure D2000 of the failure risk information storage section 2000, by which a record is uniquely determined using a failure risk and a calendar date as a key value. This data structure D2000 contains a data item 1 (failure risk [key value]), a data item 2 (calendar date (upon discovery)), a data item 3 (calendar date [key value]), a data item 4 (calendar date (part replacement due date)), a data item 5 (machine), and a data item 6 (machine cumulative operating time (upon discovery)). The data structure D2000 further contains a data item 7 (machine cumulative operating time), a data item 8 (machine cumulative operating time (part replacement due date)), a data item 9 (part), a data item 10 (part cumulative usage time (upon discovery)), a data item 11 (part cumulative usage time), and a data item 12 (part cumulative usage time (part replacement due date)).

The data structure D2000 further contains a data item 13 (measurement item), data item 14 (measured value upper limit (upon discovery)), a data item 15 (measured value (upon discovery)), a data item 16 (measured value lower limit (upon discovery)), a data item 17 (measured value upper limit), and a data item 18 (measured value). The data structure D2000 further contains a data item 19 (measured value lower limit), a data item 20 (parts failure probability (upon discovery)), a data item 21 (parts failure probability), a data item 22 (parts failure probability (part replacement due date)), a data item 23 (sign type), and a data item 24 (the related failure risks). The data structure D2000 further contains a data item 25 (order of the related failure risks), a data item 26 (number of the related failure risks), a data item 27 (order of failure risk within the related failure risks), a data item 28 (number of failure risk within the related failure risks), and a data item 29 (part replacement calendar date of the related failure risks).

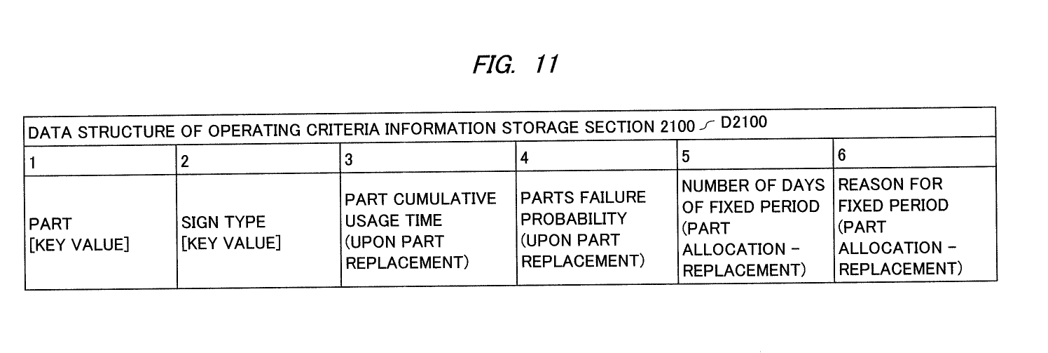

FIG. 11 is a data structure D2100 of the operating criteria information storage section 2100, by which a record is uniquely determined using a part and a sign type as a key value. This data structure D2100 contains a data item 1 (part [key value]), a data item 2 (sign type [key value]), a data item 3 (part cumulative usage time (upon part replacement)), a data item 4 (parts failure probability (upon part replacement)), a data item 5 (number of days of fixed period (part allocation-replacement)), and a data item 6 (reason for fixed period (part allocation-replacement)).

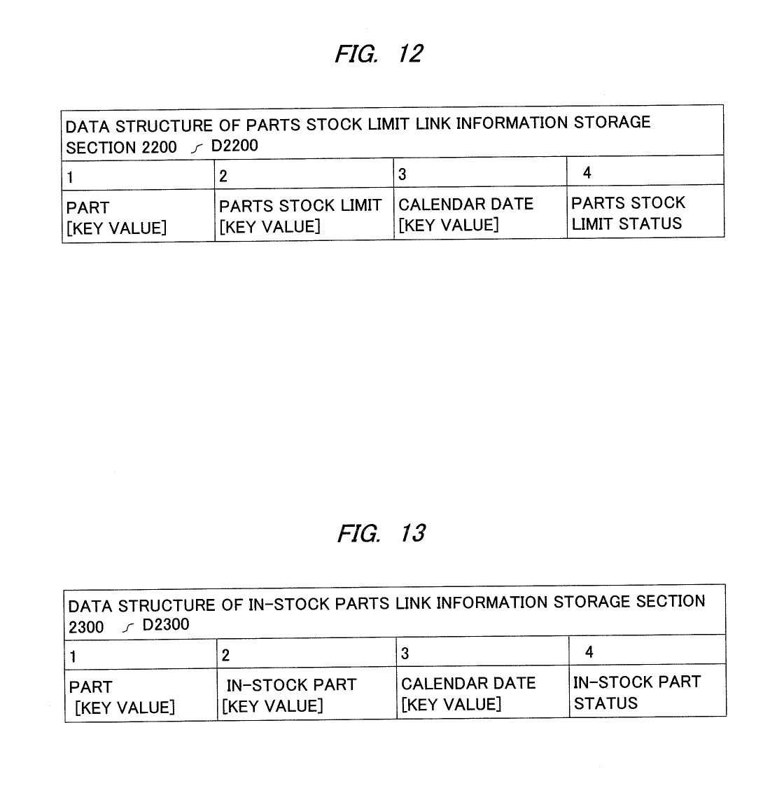

FIG. 12 is a data structure D2200 of the parts inventory frame link information storage section 2200, by which a record is uniquely determined using a part, a parts inventory frame and a calendar date as a key value. This data structure D2200 contains a data item 1 (part [ key value]), a data item 2 (parts inventory frame [ key value]), a data item 3 (calendar date [key value]), and a data item 4 (parts inventory frame status).

FIG. 13 is a data structure D2300 of the in-stock parts link information storage section 2300, by which a record is uniquely determined using a part, an in-stock part and a calendar date as a key value. This data structure D2300 contains a data item 1 (part [key value]), a data item 2 (in-stock part [key value]), a data item 3 (calendar date [key value]), and a data item 4 (in-stock part status).

<Processing Image Overview of Maintenance Parts Inventory Planning System>

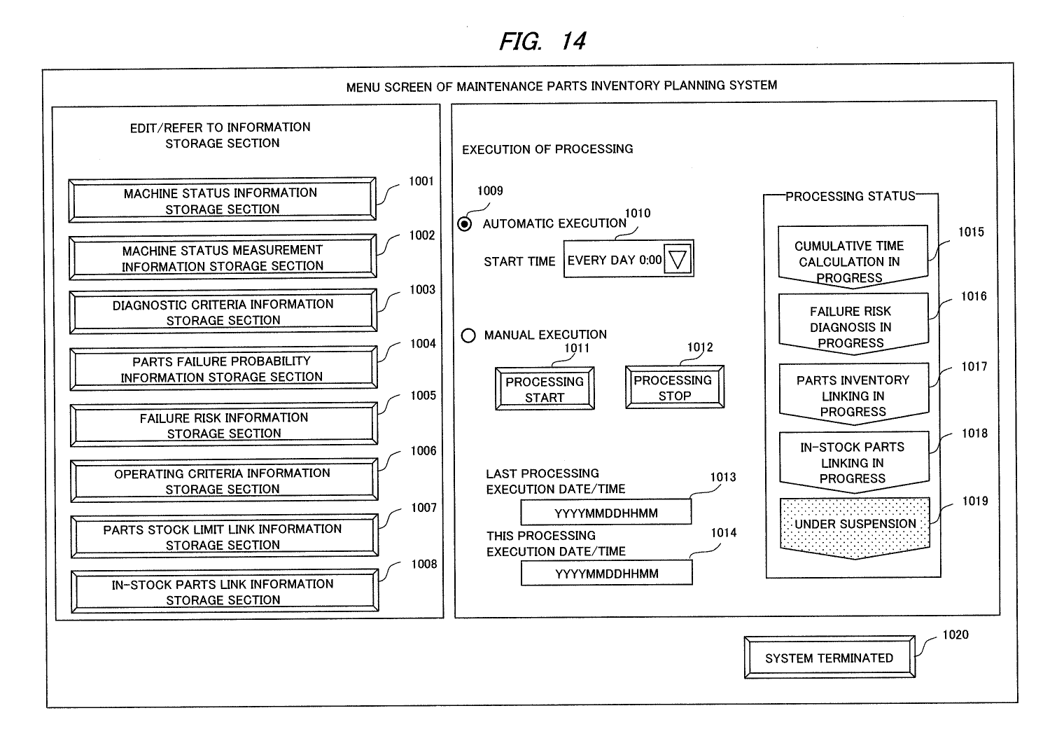

The details of screens and processing flows of the maintenance parts inventory planning system 10 according to this embodiment will be described later with reference to FIG. 14 to FIG. 30; however, antecedent to that, the following is the description for grasping a processing image overview of the maintenance parts inventory planning system 10 according to this embodiment.

For example, suppose that the last processing execution date/time of a series of processings of the maintenance parts inventory planning generation is March 31st, and this processing execution date/time is April 1st. On this processing execution date/time (April 1st), the maintenance parts inventory planning system 10 according to this embodiment grasps that the measurement of a measured value (150V) of a measurement item (s1: voltage) that measures a status of a part (p1) of a machine (g1) is made on the calendar date (March 31st).

Hereafter, the maintenance parts inventory planning system 10 according to this embodiment diagnoses that a failure risk (d1) of a sign type (y1), that is out of the range of a diagnostic criteria from a measured value lower limit (30V) to a measured value upper limit (100V) of the measurement item (s1: voltage) that measures the status of the part (p1) has occurred.

In addition, suppose that, as the operating criteria in the sign type (y1) of the part (p1), part replacement is necessary when a parts failure probability becomes (50%) (a part cumulative usage time (1000 h) at this point of time), and an operating criteria that it is necessary to perform parts inventory allocation by five days prior to a fixed period (a maintenance part transferring lead time from an intermediate warehouse that is a parts inventory allocation point to a maintenance site) has been already set in the maintenance parts inventory planning system 10 according to this embodiment. In addition, suppose that a machine operating rate of the machine (g1) on the calendar date (March 31st) is 70%, and a part cumulative usage time of the part (p1) used in the machine (g1) is 300 h.

Dividing a value (700 h) for which the part cumulative usage time (300 h) of the part (p1) used in the machine (g1) on the calendar date (March 31st) is subtracted from the part cumulative usage time (1000 h) on a timing of part replacement in the sign type (y1) of the part (p1) by the machine operating rate (70%) of the machine (g1) results in 1000 h. This corresponds to 42 days. That is, a calendar date (May 13th) for which 42 days are added to this processing execution date/time (April 1st) becomes a part replacement date. A parts inventory allocation is to be on a calendar date (May 8th) for which five days of the fixed period are subtracted from the calendar date (May 13th). That is, there is a failure risk (d1) that it is essential to schedule the parts inventory allocation on the calendar date (May 8th), and the part replacement on the calendar date (May 13th).

In the meantime, with regard to the part (p1) of the machine (g1), in a case a failure risk other than the failure risk (d1) of the sign type (y1) is present, the risks including the failure risk (d1) are called related failure risks (g1p1). By reason of either one of the failure risks included in the related failure risks (g1p1), part replacement is performed, and when a part becomes new, all failure risks included in the related failure risks (g1p1) are cleared.

As a failure risk included in the related failure risks (g1p1), there is the failure risk (d1) of the sign type (y1), a failure risk (d2) of a sign type (y2), and a failure risk (d3) of a sign type (y3). Suppose that each part replacement due date is May 13th, June 13t, and July 13th respectively, then the order of a degree of urgency of the failure risks results in the failure risk (d1) for the first place, the failure risk (d2) for the second place, and the failure risk (d3) for the third place. By allocating a parts inventory frame (w1) for the failure risk (d1) that comes in the first place in the order of the degree of urgency of the failure risks within these, a maintenance parts inventory planning is generated.

Here, the number of the parts inventory frame is set by a user on the basis of sizes and capability of a parts warehouse and a parts plant that are to be an inventory allocation point. Using a parts inventory frame, a theoretical maintenance parts inventory planning far ahead at which in-stock parts are not present yet can be designed. Furthermore, by allocating an in-stock part (b1) to the parts inventory frame (w1), a substantial maintenance parts inventory planning is generated. If a part is actually replaced, the related failure risk (g1p1) is reset.

As above, the processing image overview of the maintenance parts inventory planning system 10 according to this embodiment has been described.

<Details of Screens and Processing Flows of Maintenance Parts Inventory Planning System>

The details of screens and processing flows of the maintenance parts inventory planning system 10 according to this embodiment will be described with reference to FIG. 14 to FIG. 30.

The maintenance parts inventory planning system 10 according to this embodiment is provided with, a screen such as that shown in, for example, FIG. 14 to FIG. 22. FIG. 14 to FIG. 22 will be described below with reference to data structures of FIG. 5 to FIG. 13.

<Menu Screen of Maintenance Parts Inventory Planning System>

The maintenance parts inventory planning system 10 according to this embodiment display a menu screen of the maintenance parts inventory planning system such as, for example, FIG. 14. A screen of FIG. 14 has in memory, a data structure such as the data structure D1100 of a screen for a plan generation procedure control processing section 1100 shown in FIG. 5.

The left part of FIG. 14 displays a screen for editing/referring to each information storage section corresponding to each of 1001-1008 upon receipt of a push-down 19 of buttons 1001-1008 from a user. The 1001 is a button for displaying a screen for editing/referring to the machine status information storage section 1600. The 1002 is a button for displaying a screen for editing/referring to the machine status measurement information storage section 1700. The 1003 is a button for displaying a screen for editing/referring to the diagnostic criteria information storage section 1800. The 1004 is a button for displaying a screen for editing/referring to the parts failure probability information storage section 1900. The 1005 is a button for displaying a screen for referring to the failure risk information storage section 2000. The 1006 is a button for displaying a screen for editing/referring to the operating criteria information storage section 2100. The 1007 is a button for displaying a screen for editing/referring to the parts inventory frame link information storage section 2200. The 1008 is a button for displaying a screen for editing/referring to the in-stock parts link information storage section 2300.

When each of these buttons is pushed down, a value indicating in use is written in each of the flags of the data item 1 to the data item 8 of the data structure D1100 of FIG. 5, and when the screen of each information storage section is closed, a value indicating not in use is written in each flag. In these flags, when a series of processings of the maintenance parts inventory planning generation are executed, the value indicating in use is written so as to prevent deadlock and data mismatching.

The right part of FIG. 14 displays a series of processings until the maintenance parts inventory planning generation is started by a corresponding method/time pattern upon receipt of from a user an input relating to an execution of a series of processings until the maintenance parts inventory planning generation and displays a processing progress. A specification of an automatic execution or a manual execution received by the 1009 of FIG. 14 is written in the processing division of the data item 9 of the data structure D1100 of FIG. 5. When the 1009 of FIG. 14 is the automatic execution, a start time pattern received by the 1010 of FIG. 14 is written in the start time pattern of the data item 10 of FIG. 5. When it gets to said start time, or when a push-down on the processing start button of the 1011 of FIG. 14 is received, the processing status of the data item 11 of FIG. 5 is changed from under suspension to a status corresponding to the series of processings of the maintenance parts inventory planning generation, and at the same time, a color of processing statuses in progress of the 1015-1019 of FIG. 14 is changed, thereby displaying a processing progress. The 1012 of FIG. 14 is a processing stop button of manual execution.

A last processing execution date/time and this processing execution date/time are displayed in the 1013 and 1014 of FIG. 14. For example, a process for displaying the screen of FIG. 14 resides in a running state in memory of 24-hour operating computer, and is terminated upon receipt of a push-down on a system terminated button of the 1020 of FIG. 14.

<Screen for Editing/Referring to Machine Status Information>

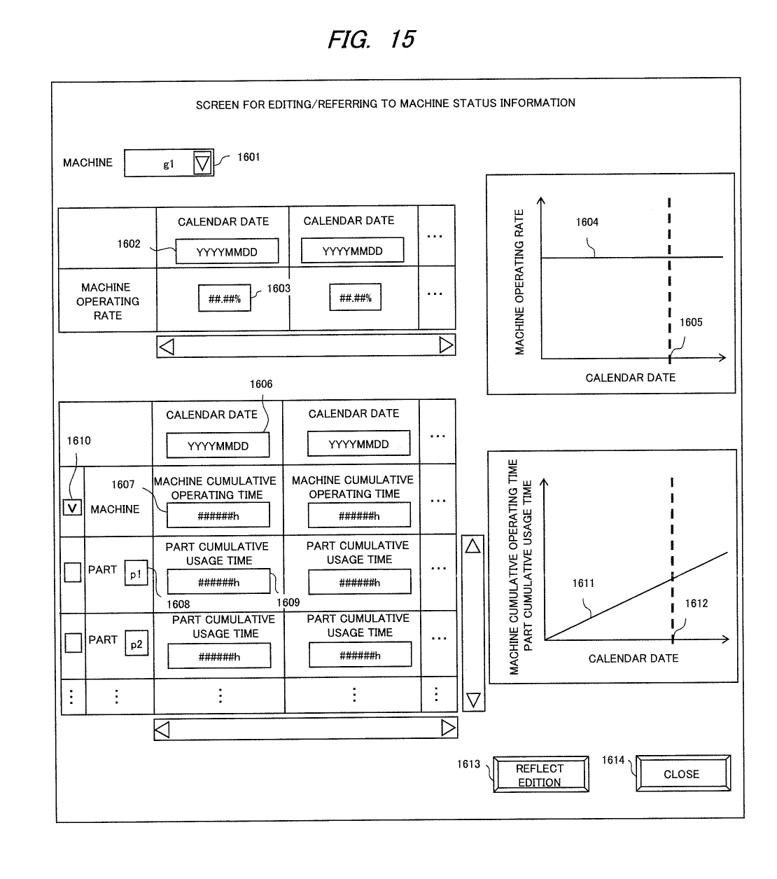

The maintenance parts inventory planning system 10 according to this embodiment displays, for example, the screen for editing/referring to machine status information such as FIG. 15 upon receipt of a push-down on the button 1001 for displaying the screen for editing/referring to machine status information of the left part of the screen of FIG. 14. The screen of FIG. 15 displays a data structure such as the data structure 1600D of the machine status information storage section 1600 shown in FIG. 6.

The screen of FIG. 15 receives a specification of a machine 1601 for editing/referring to machine status information, displays a machine operating rate 1603 per calendar date 1602 of said machine in an upper part of the left part of FIG. 15, and displays in a graph a value per calendar date of a machine operating rate 1604 in an upper part of the right part of FIG. 15. A calendar date 1605 on the graph indicates this processing execution date/time 1014 of FIG. 14. For example, an actual value falls for the past before the calendar date 1605, and a probable value for which a recent past actual value is considered to continue ever after falls for the future the calendar date 1605.

A machine cumulative operating time 1607 per calendar date 1606 of said machine and a part cumulative usage time 1609 of a part 1608 constituting a main body of said machine are displayed in a lower part of the lower part of the left part of FIG. 15, and a value per calendar date of a machine cumulative operating time and part cumulative usage time 1611 specified in a display selection 1610 of the lower part of the left part of FIG. 15 is displayed in a graph in a lower part of the right part of FIG. 15. A calendar date 1612 on the graph indicates this processing execution date/time 1014 of FIG. 14.

For example, an actual value falls for the past before the calendar date 1612, and a probable value calculated by this system falls for the future after the calendar date 1612. In this embodiment, a value input by a user from this system is used for the actual value, and a case where the probable value depends on a cumulative time calculation processing of this system is illustrated, however, other than this, the manner in which information in an external means is retrieved into this system as the actual value and probable value may be used.

Upon receipt of a push-down on a reflect edition button 1613, editing content of the screen of FIG. 15 is reflected to the machine status information storage section 1600. Upon receipt of a push-down on a close button 1614, the screen of FIG. 15 is closed.

<Screen for Editing/Referring to the Machine Status Measurement Information>

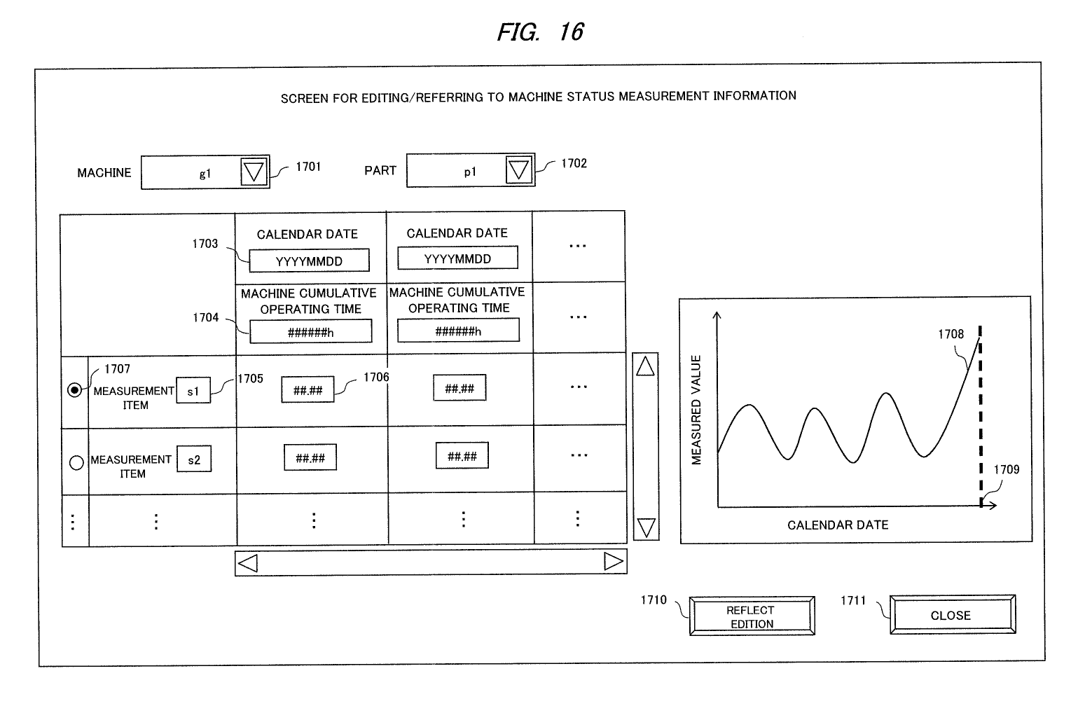

The maintenance parts inventory planning system 10 according to this embodiment displays, for example, the screen for editing/referring to the machine status measurement information such as FIG. 16 upon receipt of a push-down on a button 1002 of the left part of the screen of FIG. 14 for displaying the screen for editing/referring to the machine status measurement information. The screen of FIG. 16 displays a data structure such as the data structure D1700 of the machine status measurement information storage section 1700 shown in FIG. 7

The screen of FIG. 16 receives a specification of a machine 1701 and a part 1702 for editing/referring to the machine status measurement information, displays, with regard to said machine 1701 and said part 1702, a part cumulative usage time 1704 per calendar date 1703 and a measured value 1706 for every measurement item 1705 in the left part of FIG. 16, and displays in a graph in the right part of FIG. 16 a value per calendar date 1703 of a measured value 1708 specified in a display selection 1707 of the left part of FIG. 16. A calendar date 1709 on the graph indicates this processing execution date/time 1014 of FIG. 14.

In this embodiment, the machine status measurement information is intended for only past actual values, and a value input by a user from this system is used. Other than this, a future probable value may be included in the object. The manner in which information in an external means is retrieved into this system as the actual value and probable value may be used.

Upon receipt of a push-down on a reflect edition button 1710, editing content of the screen of FIG. 16 is reflected to the machine status measurement information storage section 1700. Upon receipt of a push-down on a close button 1711, the screen of FIG. 16 is closed.

<Screen for Editing/Referring to the Diagnostic Criteria Information>

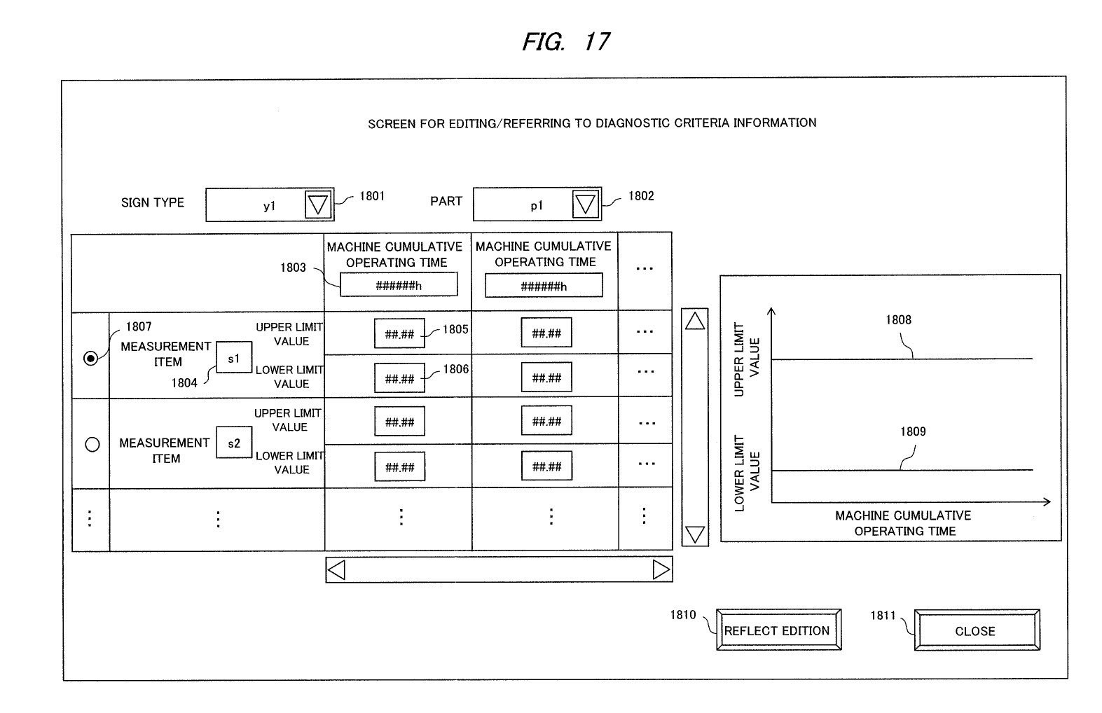

The maintenance parts inventory planning system 10 according to this embodiment displays, for example, the screen for editing/referring to the diagnostic criteria information such as FIG. 17 upon receipt of a push-down on a button 1003 of the left part of the screen of FIG. 14 for displaying the screen for editing/referring to the diagnostic criteria information. The screen of FIG. 17 displays a data structure such as the data structure D1800 of the diagnostic criteria information storage section 1800 shown in FIG. 8.

The screen of FIG. 17 receives a specification of a sign type 1801 and a part 1802 for editing/referring to the diagnostic criteria information, displays, with regard to said sign type 1801 and said part 1802, a measured value upper limit 1805 and a measured value lower limit 1806 of a measurement item 1804 per part cumulative usage time 1803 in the left part of FIG. 17, and displays in a graph in the right part of FIG. 17 a value per part cumulative usage time 1803 of a measured value upper limit 1808 and a measured value lower limit 1809 specified in a display selection 1807 of the left part of FIG. 17.

In this embodiment, a value input by a user from this system is used for the measured value upper limit 1808 and the measured value lower limit 1809. Other than this, the manner in which information in an external means is retrieved into this system may be used.

Upon receipt of a push-down on a reflect edition button 1810, editing content of the screen of FIG. 17 is reflected to the diagnostic criteria information storage section 1800. Upon receipt of a push-down on a close button 1811, the screen of FIG. 17 is closed.

<Screen for Editing/Referring to the Parts Failure Probability Information>

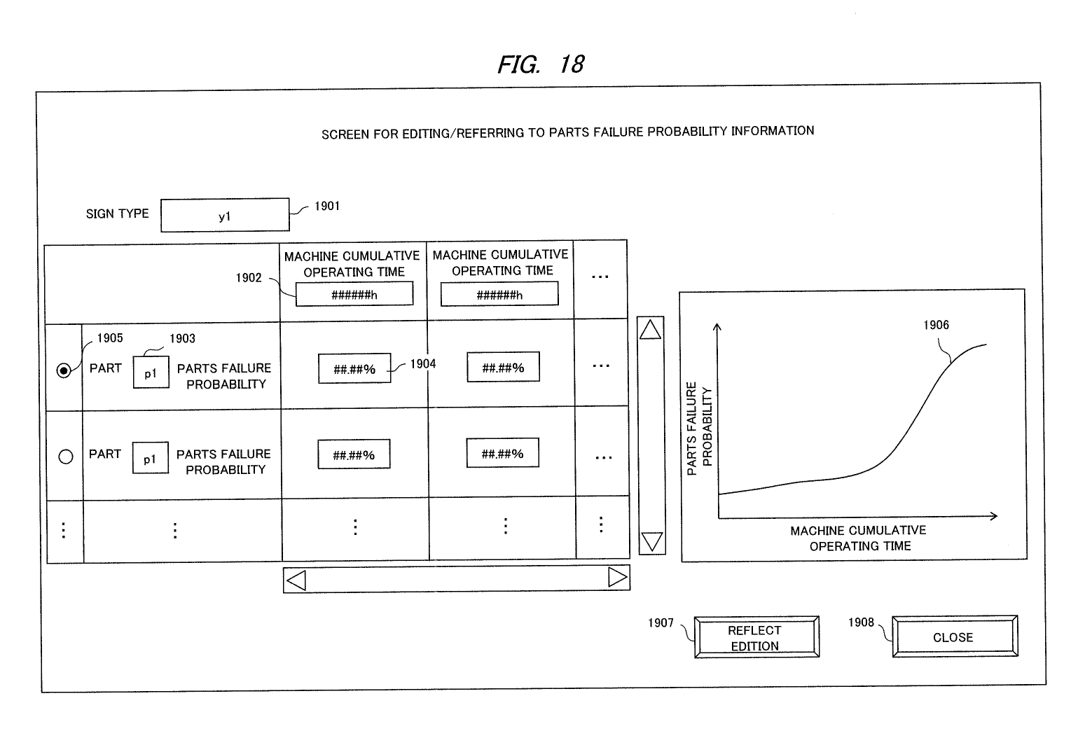

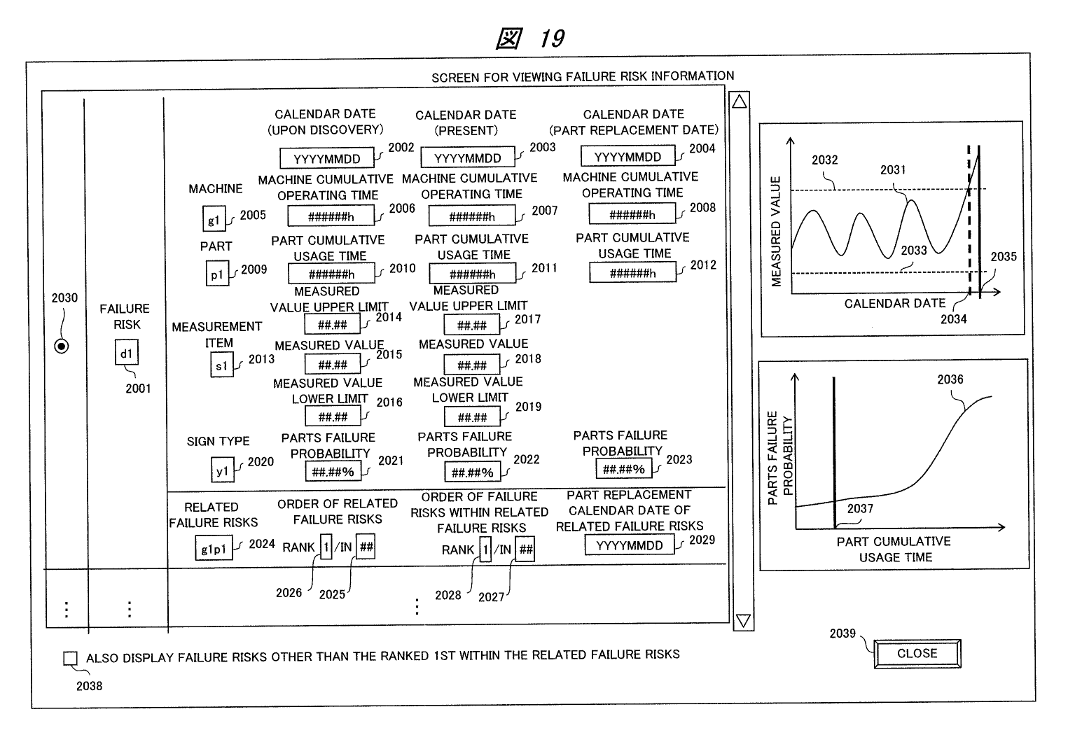

The maintenance parts inventory planning system 10 according to this embodiment displays, for example, the screen for editing/referring to the parts failure probability information such as FIG. 18 upon receipt of a push-down on a button 1004 of the left part of the screen of FIG. 14 for displaying the screen for editing/referring to the parts failure probability information. The screen of FIG. 18 displays a data structure such as the data structure D1900 of the parts failure probability information storage section 1900 shown in FIG. 9.

The screen of FIG. 18 receives a specification of a sign type 1901 for editing/referring to the parts failure probability information, displays, with regard to said sign type 1901, a parts failure probability 1904 for every part 1903 per part cumulative usage time 1902 in the left part of FIG. 18, and displays in a graph in the right part of FIG. 18 a value per part cumulative usage time 1902 of a parts failure probability 1906 specified in a display selection 1905 of the left part of FIG. 18.

In this embodiment, a value input by a user from this system is used for parts failure probability 1904. Other than this, the manner in which information in an external means is retrieved into this system may be used.

Upon receipt of a push-down on a reflect edition button 1907, editing content of the screen of the screen of FIG. 18 is reflected to the parts failure probability information storage section 1900. Upon receipt of a push-down on a close button 1908, the screen of FIG. 18 is closed.

<Screen for Referring to the Failure Risk Information>

The maintenance parts inventory planning system 10 according to this embodiment displays, for example, the screen for referring to the failure risk information such as FIG. 19 upon receipt of a push-down on a button 1005 of the left part of the screen of FIG. 14 for displaying the screen for referring to the failure risk information. The screen of FIG. 19 displays a data structure such as the data structure D2000 of the failure risk information storage section 2000 shown in FIG. 10.

The screen of FIG. 19 displays information concerning a failure risk 2001 generated by the failure risk diagnosis processing section 1200 of this system. In the left part of the screen of FIG. 19, a calendar date at the time of discovering a sign of a failure is displayed in a calendar date (upon discovery) 2002, this processing execution date/time 1014 of FIG. 14 is displayed in a calendar date (present) 2003, and a calendar date to be a part replacement due date due to said failure risk per se is displayed in a calendar date (part replacement due date) 2004.

A machine cumulative operating time of a machine 2005 on said calendar date (upon discovery) 2002, said calendar date (present) 2003 and said calendar date (part replacement due date) 2004 is displayed in 2006, 2007 and 2008 of the left part of the screen of FIG. 19.

Apart cumulative usage time of apart 2009 used in said machine 2005 on said calendar date (upon discovery) 2002, said calendar date (present) 2003, said calendar date (part replacement due date) 2004 is displayed in 2010, 2011 and 2012 of the left part of the screen of FIG. 19.

A measured value upper limit, a measured value and a measured value lower limit of a measurement item 2013 for diagnosing a sign of said part 2009 used in said machine 2005 on said calendar date (upon discovery) 2002 and said calendar date (present) 2003 are displayed in 2014, 2015, 2016, 2017, 2018 and 2019 of the left part of the screen of FIG. 19.

A parts failure probability of a sign type 2020 which is diagnosed for said part 2009 used in said machine 2005 on said calendar date (upon discovery) 2002, said calendar date (present) 2003 and said calendar date (part replacement due date) 2004 is displayed in 2021, 2022 and 2023 of the left part of the screen of FIG. 19.

A related failure risk 2024 indicating a collection of all failure risks other than said failure risk 2001 relating to said part 2009 used in said machine 2005 is displayed in the left part of the screen of FIG. 19. Furthermore, an order 2026 of a degree of urgency of said related failure risk 2024 within all of the number of the related failure risk 2025 including said related failure risk 2024, an order 2028 of a degree of urgency of said failure risk 2001 within the number of the related failure risk 2027 including said related failure risk 2024, and a part replacement calendar date of the related failure risks 2029 for replacing said part 2009 used in said machine 2005 related to said related failure risk 2024 are displayed in the left part of the screen of FIG. 19.

The right part of the screen of FIG. 19 displays in a graph, a measured value 2031 of a measurement item 2013 of a failure risk 2001 specified in a display selection 2030 of the left part of the screen of FIG. 19, a measured value upper limit 2032 and a measured value lower limit 3033 per calendar date of the data item 3 of the data structure D2000 of the failure risk information storage section 2000 of FIG. 10. In addition to that, a calendar date 2034 indicating the calendar date (present) 2003 and a calendar date 2035 indicating the calendar date (part replacement due date) 2004 are displayed in a graph.

In addition, the right part of the screen of FIG. 19 reads in parts failure probability 2036 per part cumulative usage time relating to the failure risk 2001 specified in the display selection 2030 of the left part of the screen of FIG. 19 from the parts failure probability information storage section 1900 using said sign type 2020 of said failure risk 2001 and said part 2009 as keys, and displays same in a graph. In addition to that, a part cumulative usage time 2037 on the calendar date (present) 2003 is displayed in a graph.

Upon receipt of a display selection 2038, this system selects whether or not failure risks other than that in the first place within the order within the related failure risks are displayed. In this embodiment, information concerning the failure risk 2001 is generated by the failure risk diagnosis processing section 1200 of this system. Other than this, the manner in which information in an external means is retrieved into this system may be used.

Upon receipt of a push-down of a close button 2039, the screen of FIG. 19 is closed.

<Screen for Editing/Referring to the Operating Criteria Information>

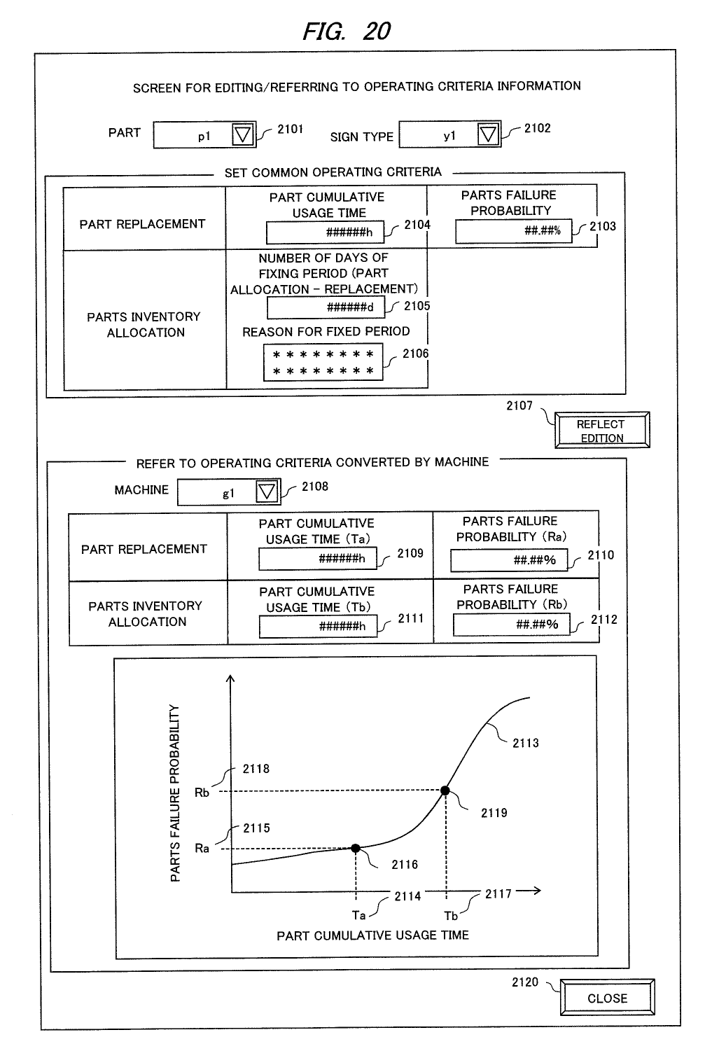

The maintenance parts inventory planning system 10 according to this embodiment displays, for example, the screen for editing/referring to the operating criteria information such as FIG. 20 upon receipt of a push-down on a button 1006 of the left part of the screen of FIG. 14 for displaying the screen for editing/referring to the operating criteria information. The screen of FIG. 20 displays a data structure such as the data structure D2100 of the operating criteria information storage section 2100 shown in FIG. 11.

The screen of FIG. 20 receives a specification of a part 2101 and a sign type 2102 for editing/referring to the operating criteria information, and with regard to said part 2101 and said sign type 2102, sets operating criteria common to all machines in the upper part of the screen of FIG. 20.

First, an input for a parts failure probability 2103 upon part replacement is received, and a part cumulative usage time 2104 of a record having said sign type 2102, said part 2101 and said parts failure probability 2103 as keys of the parts failure probability information storage section 1900 is displayed. Here, on the contrary, an input for a part cumulative usage time 2104 may be received, and a parts failure probability 2103 of a record having said sign type 2102, said part 2101 and said part cumulative usage time 2104 as keys of the parts failure probability information storage section 1900 may be displayed.

Next, inputs for the number of days of fixed period (part allocation-replacement) 2105 that indicates how earlier than a part replacement a parts inventory allocation should be performed and a reason for fixed period 2106 are received. For the reason for fixed period 2106, there are, for example, a lead time for moving a maintenance part from a parts warehouse to a maintenance site, and a period for which a lead time for producing a maintenance part to be reproduced from a production allocation point of a part reproduction plant and a lead time for moving said maintenance part to be reproduced from said part reproduction plant to said maintenance site are combined.

Upon receipt of a reflect edition button 2107, the abovementioned editing content is reflected to the operating criteria information storage section 2100.

In a lower part of the screen of FIG. 20, a selection by said machine 2108 which wants to refer operating criteria converted for every machine out of a plurality of machines 2108 for which a sign of said sign type 2102 is diagnosed regarding said part 2101 is received.

A part cumulative usage time 2109 of said machine 2108 upon part replacement is transcribed from a part cumulative usage time 2104 of a common setting. A part cumulative usage time 2111 of parts inventory allocation of said machine 2108 displays a value for which a value for which the number of days of fixed period 2105 of a parts inventory allocation of the common setting is multiplied by a machine operating rate of a record of the machine status information storage section 1600 having said machine 2108, said part 2101 and said part cumulative usage time 2104 as keys is subtracted from said part cumulative usage time 2104 of part replacement of the common setting.

A parts failure probability 2110 of a part replacement of said machine 2108 displays a parts failure probability of a record of parts failure probability information storage section 1900 having said part 2101 and said part cumulative usage time 2109. A parts failure probability 2112 of a parts inventory allocation of said machine 2108 displays a parts failure probability of the record of parts failure probability information storage section 1900 having said part 2101 and said part cumulative usage time 2111 as keys.

A graph same as that displayed in the right part of the screen for editing/referring to the parts failure probability information of FIG. 18 is displayed in 2113. With regard to sign type 2102 of said part 2101 of said machine 2108, a point 2116 of a parts failure probability 2115 in a part cumulative usage time 2114 upon parts inventory allocation is displayed with a point 2119 of a parts failure probability 2118 in a part cumulative usage time 2117 upon part replacement together thereon.

Upon receipt of a push-down of a close button 2120, the screen of FIG. 20 is closed.

<Screen for Editing/Referring to the Parts Inventory Frame Link Information>

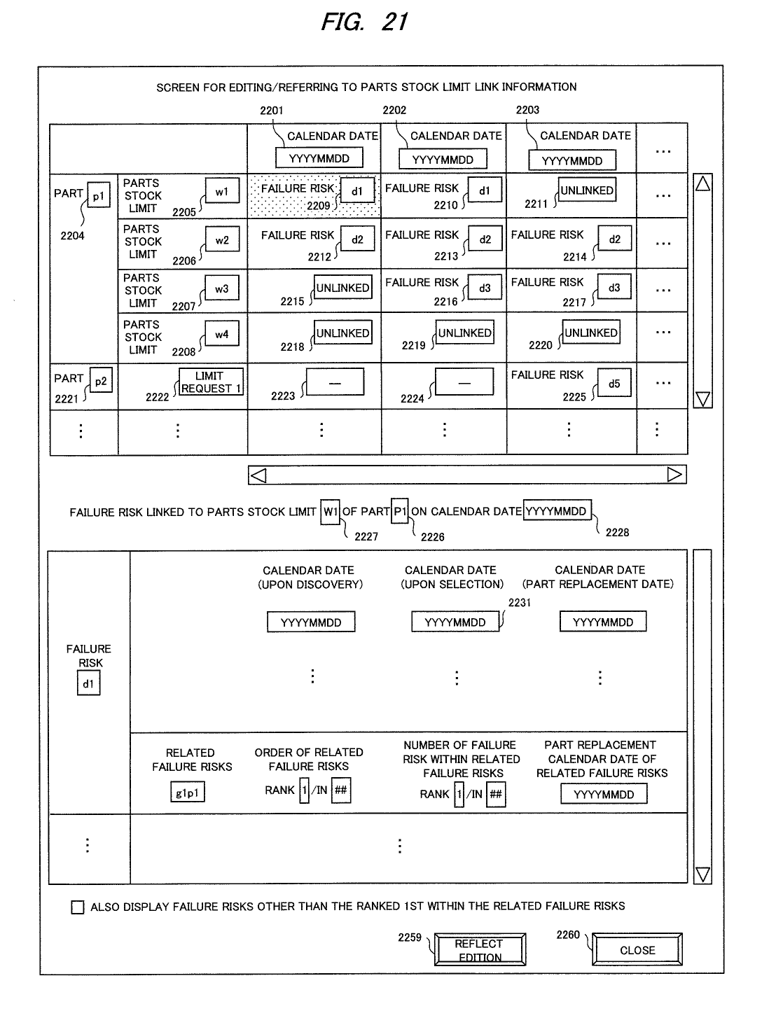

The maintenance parts inventory planning system 10 according to this embodiment displays, for example, the screen for editing/referring to the parts inventory frame link information such as FIG. 21 upon receipt of a push-down on a button 1007 of the left part of the screen of FIG. 14 for displaying the screen for editing/referring to the parts inventory frame link information. The screen of FIG. 21 displays a data structure such as the data structure D2200 of the parts inventory frame link information storage section 2200 shown in FIG. 12.

In the upper part of the screen of FIG. 21, a maintenance parts inventory planning generated by the parts inventory frame link information processing section 1300 of this system is displayed. The example of FIG. 21 illustrates that, on a calendar date 2201, a calendar date 2202 and a calendar date 2203, a part (p1) 2204 has four parts inventory frames (parts inventory frame (w1) 2205, parts inventory frame (w2) 2206, parts inventory frame (w3) 2207 and parts inventory frame (w4) 2208), and a part (p2) 2221 does not have a parts inventory frame and requests a parts inventory frame ((frame request 1) 2222).

The parts inventory frame (w1) 2205 displays a failure risk (d1) 2209, a failure risk (d1) 2210 and (unlinked) 2211 on the calendar date 2201, calendar date 2202 and calendar date 2203. This is a value of the parts inventory frame status of the data item 4 of the data structure D2200 of the parts inventory frame link information storage section 2200 of FIG. 12.

It is illustrated that, to the parts inventory frame (w1) 2205, a failure risk (d1) 2209/2210 is linked on the calendar date 2201 and calendar date 2202, and a failure risk is not linked on the calendar date 2203. That is, it is indicated that, on the calendar date 2203, an in-stock part linked to the parts inventory frame (w1) 2205 is retrieved from a warehouse for a part replacement, and the parts inventory frame (w1) 2205 was released and became (unlinked) 2211.

It is illustrated that a failure risk (d2) 2212, a failure risk (d2) 2213 and a failure risk (d2) 2214 are linked to a parts inventory frame (w2) 2206 on the calendar date 2201, calendar date 2202 and calendar date 2203. In the screen of FIG. 21, it can be seen that the failure risk (d2) is linked to the parts inventory frame (w2) 2206, however, it cannot be seen that whether or not the parts inventory frame (w2) 2206 is linked to an in-stock part.

The parts inventory frame (w3) 2207 displays (unlinked) 2215, failure risk (d3) 2216 and failure risk (d3) 2217 on the calendar date 2201, calendar date 2202 and calendar date 2203.

It is illustrated that, to a parts inventory frame (w3) 2207, a failure risk is not linked on the calendar date 2201, and a failure risk (d3) 2216/2217 is linked on the calendar date 2202 and calendar date 2203. This indicates that, at the time of the calendar date 2201, the number of a failure risk that needs to be linked to a parts inventory frame is smaller than the number of parts inventory frame, and the parts inventory frame (w3) 2207 is available.

It is illustrated that, the parts inventory frame (w4) 2208 is all (unlinked) 2218/2219/2220 and available on the calendar date 2201, calendar date 2202 and calendar date 2203.

The part (p2) 2221 is in a state where a parts inventory frame is not present, and displays (-) 2223/2224 on the calendar date 2201 and calendar date 2202, however, on the calendar date 2203, a failure risk that needs to be linked to a parts inventory frame (d5) 2225 is occurred, and thus, displays a (frame request 1) 2222 that is a parts inventory frame status for requesting generation of a parts inventory frame.

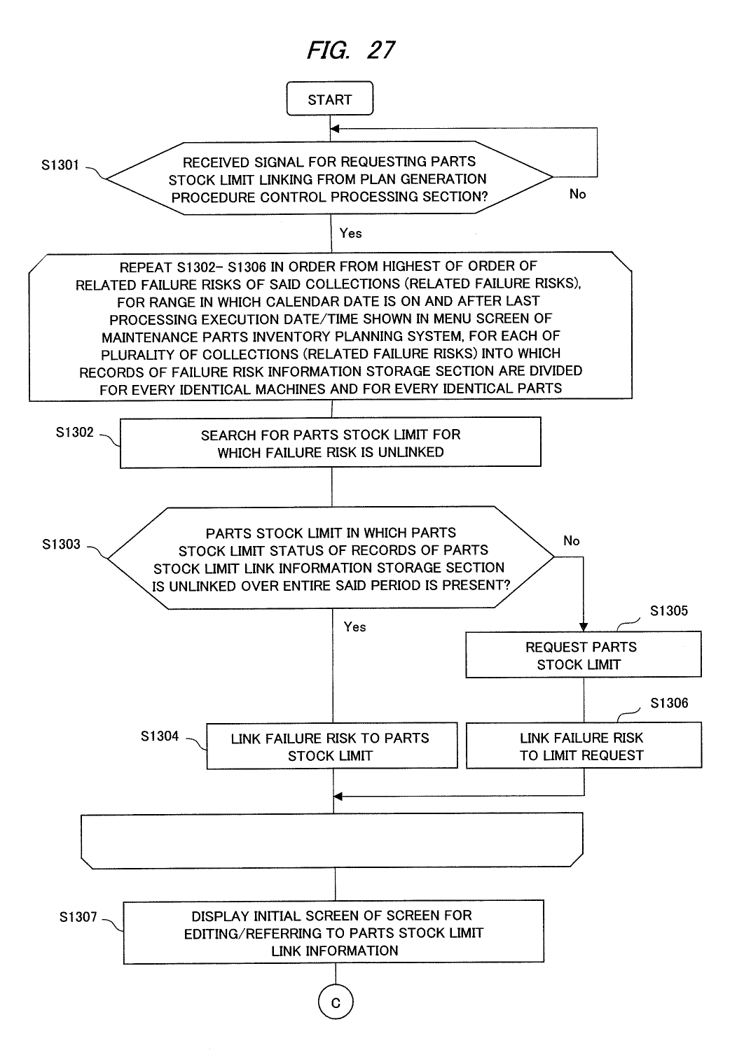

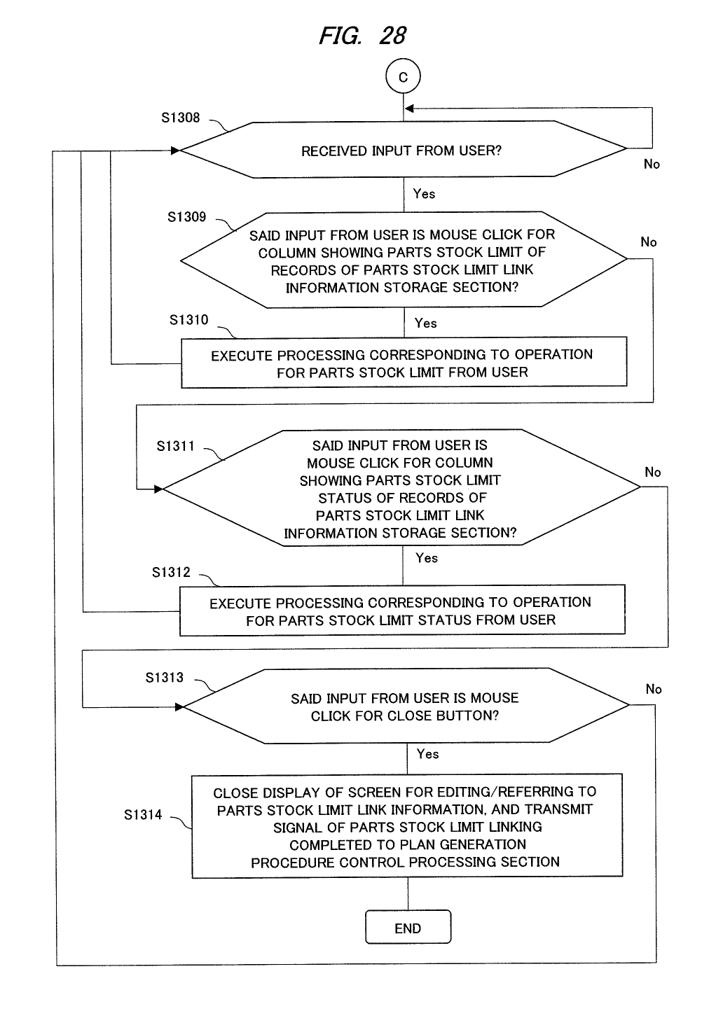

An addition/deletion of a parts inventory frame and a response to a frame request will be described later with reference to processing flows of FIG. 27 and FIG. 28.

In a lower part of the screen of FIG. 21, a failure risk 2209 that is selected in the upper part of the screen of FIG. 21 to be displayed and information concerning the calendar date 2201 (a failure risk linked to a parts inventory frame 2227 of a part 2226 on a calendar date 2228) are displayed. Although almost equivalent to that displayed in the left part of the screen for referring to the failure risk information FIG. 19, the screen of FIG. 19 displays information of the failure risk information storage section 2000 with a failure risk and the calendar date (present) 2003 as key values, whereas FIG. 21 displays the information of the failure risk information storage section 2000 with a calendar date (upon selection) 2231, not a calendar date (present), along with a failure risk as key values. In FIG. 21, the same part as FIG. 19 is omitted.

In this embodiment, a processing result by the parts inventory frame link processing section 1300 of this system and an input from a user are used. Other than this, the manner in which information in an external means is retrieved into this system may be used.

Upon receipt of a push-down of a reflect edition button 2259, editing content of the screen of FIG. 21 is reflected to the parts inventory frame link information storage section 2200. Upon receipt of a push-down of a close button 2260, the screen of FIG. 21 is closed.

<Screen for Editing/Referring to the In-Stock Parts Link Information>

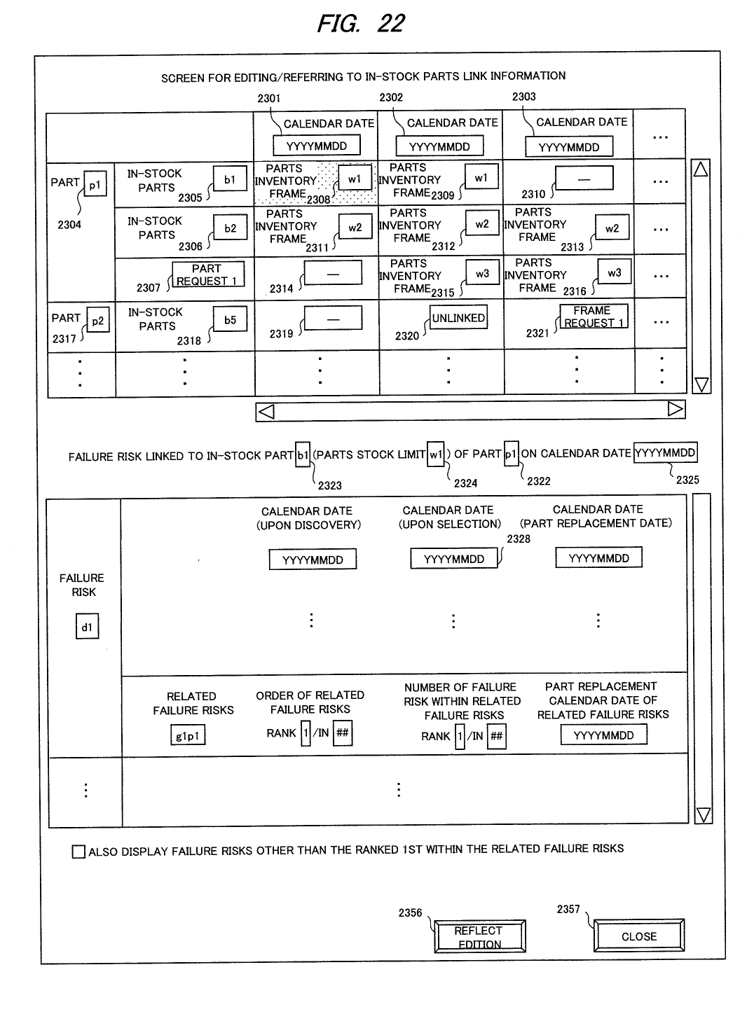

The maintenance parts inventory planning system 10 according to this embodiment displays, for example, the screen for editing/referring to the in-stock parts link information such as FIG. 22 upon receipt of a push-down on a button 1008 of the left part of the screen of FIG. 14 for displaying the screen for editing/referring to the in-stock parts link information. FIG. 22 displays a data structure such as the data structure D2300 of the in-stock parts link information storage section 2300 shown in FIG. 13.

In the upper part of FIG. 22, a maintenance parts inventory planning generated by the in-stock parts link information processing section 1400 of this system is displayed. In the example of FIG. 22, on a calendar date 2301, calendar date 2302 and calendar date 2303, apart (p1) 2304 has two in-stock parts, an in-stock part (in-stock part (b1) 2305 and an in-stock part (b2) 2306), however, one in-stock part is further requested ((part request 1) 2307), and thus it is indicated that a part (p2) 2317 has one in-stock part (in-stock part (b5) 2318).

The in-stock part (b1) 2305 displays, on the calendar date 2301, calendar date 2302 and calendar date 2303, a parts inventory frame (w1) 2308, parts inventory frame (w1) 2309 and (-) 2310. This is a value of the in-stock part status of data item 4 of the data structure D2300 of the in-stock parts link information storage section 2300 of FIG. 13.

It is illustrated that, to the in-stock part (b1) 2305, a parts inventory frame (w1) 2308/2309 is linked, on the calendar date 2301 and calendar date 2302, and in-stock part (b1) is not present on the calendar date 2303. That is, it is indicated that, on the calendar date 2303, the in-stock part (b1) 2305 is retrieved from a warehouse for a part replacement. In addition, at this point of time, the parts inventory frame (w1) is released and the parts inventory frame status becomes (unlinked).

It is illustrated that, to the in-stock part (b2) 2306 a parts inventory frame (w2) 2311, parts inventory frame (w2) 2312 and parts inventory frame (w2) 2313 are linked on the calendar date 2301, calendar date 2302 and calendar date 2303.

For the (part request 1) 2307, (-) 2314, parts inventory frame (w3) 2315 and parts inventory frame (w3) 2316 are displayed on the calendar date 2301, calendar date 2302 and calendar date 2303.

It is illustrated that the (part request 1) 2307 is not in a warehouse yet on the calendar date 2301, and is linked to a parts inventory frame (w3) 2315/2316 on the calendar date 2302 and calendar date 2303. That is, it is illustrated that, at the time of the calendar date 2302, a failure risk needed to be linked to a parts inventory frame occurs, and said failure risk is linked to the parts inventory frame (w3) 2315, and thus it is necessary that the parts inventory frame (w3) is linked to an in-stock part, and a (part request 1) 2307 is displayed.

For an in-stock part (b5) 2318 of part (p2) 2317, (-) 2319, (unlinked) 2320 and a (frame request 1) 2321 are displayed on the calendar date 2301, calendar date 2302 and calendar date 2303.

The in-stock part (b5) is not in a warehouse at the time of the calendar date 2301, and put into the warehouse at the time of the calendar date 2302, however, a parts inventory frame for a requesting an in-stock part is not present, and thus is in a state of unlinked. Furthermore, a failure risk needed to be linked to a parts inventory frame occurs at the time of the calendar date 2303, however, the parts inventory frame is not present, and thus a frame request for requesting a parts inventory frame is generated. It is illustrated that said frame request requires a link to an in-stock part, and therefore said frame request is linked to the in-stock part (b5).

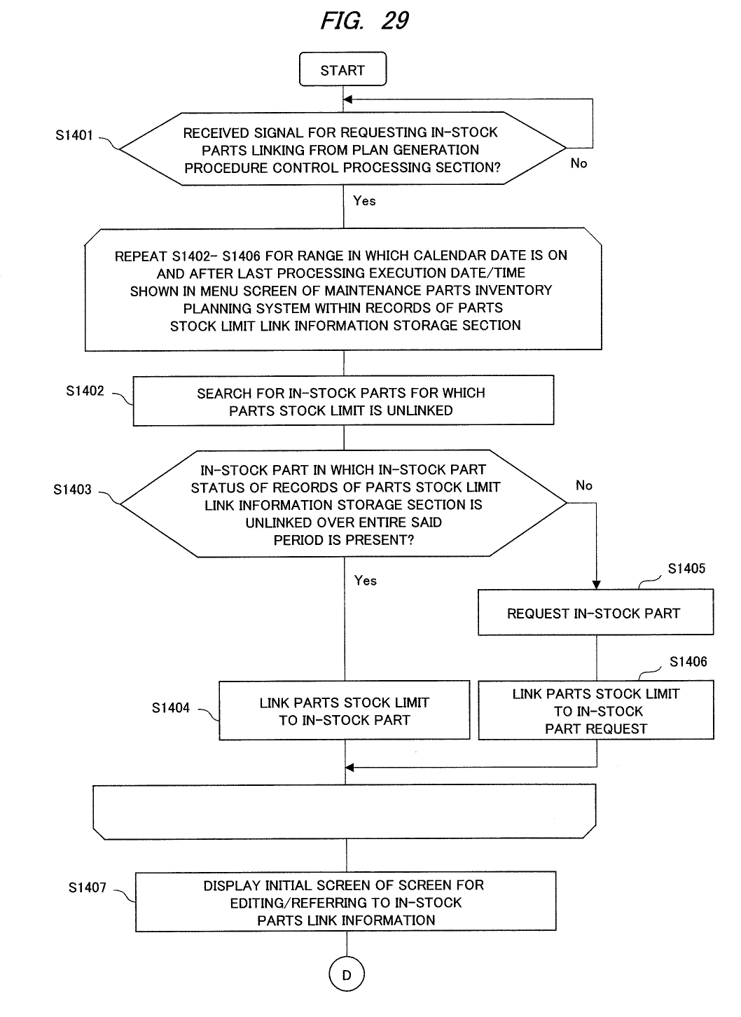

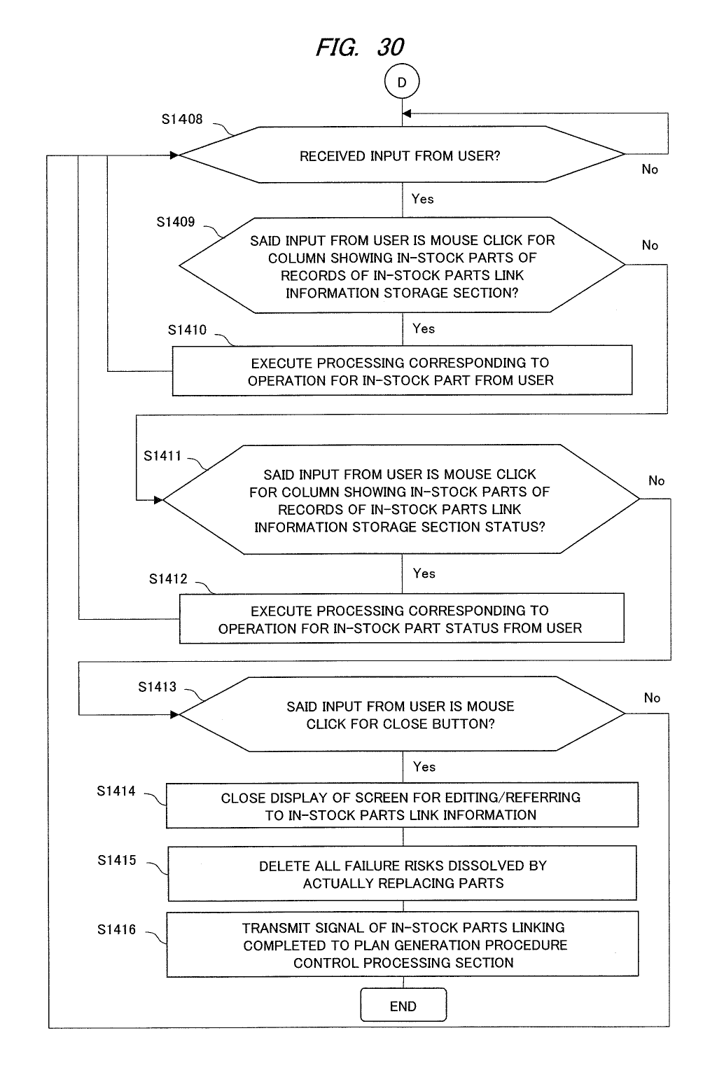

An addition/deletion of an in-stock part and a response to an in-stock part will be described later with reference to processing flows of FIG. 29 and FIG. 30. In addition, a response to a frame request is handled by the screen for editing/referring to the parts inventory frame link information of FIG. 21 and processing flows that are illustrated later in FIG. 27 and FIG. 28.

In a lower part of the screen of FIG. 22, a parts inventory frame 2308 that is selected in the upper part of the screen of FIG. 22 to be displayed and information concerning on the calendar date 2301 (a failure risk linked to an in-stock part 2323 (parts inventory frame 2324) of a part 2322 on a calendar date 2325) are displayed. Although almost equivalent to that displayed in the left part of the screen for referring to the failure risk information FIG. 19, the screen of FIG. 19 displays information of the failure risk information storage section 2000 with a failure risk and the calendar date (present) 2003 as key values, whereas FIG. 22 displays the information of the failure risk information storage section 2000 with a calendar date (upon selection) 2328, not a calendar date (present), along with a failure risk as key values. In FIG. 22, the same part as FIG. 19 is omitted.

In this embodiment, a processing result by the in-stock parts link processing section 1400 of this system and an input from a user are used. Other than this, the manner in which information in an external means is retrieved into this system may be used.

Upon receipt of a push-down of a reflect edition button 2356, editing content of the screen of FIG. 22 is reflected to the in-stock parts link information storage section 2300. Upon receipt of a push-down of a close button 2357, the screen of FIG. 22 is closed.

<Processing Flow Relating to Plan Generation Procedure Control Processing Section>

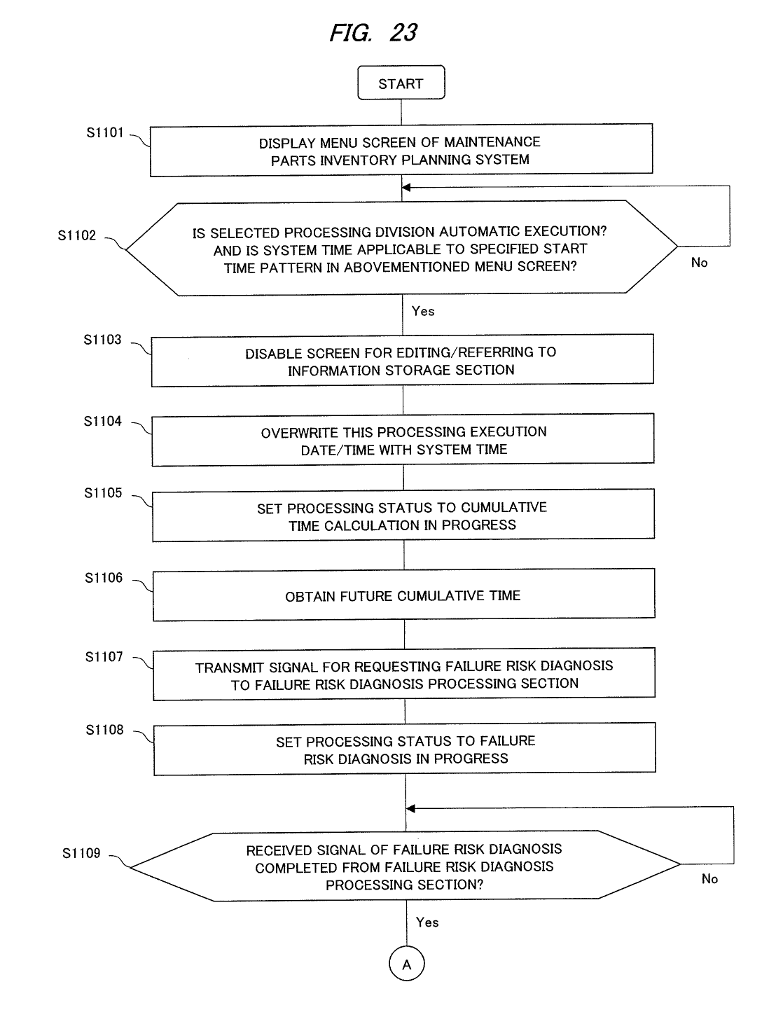

The maintenance parts inventory planning system 10 according to this embodiment operates along with processing flows such as that shown in, for example, FIG. 23-FIG. 30, which will be described in details below.

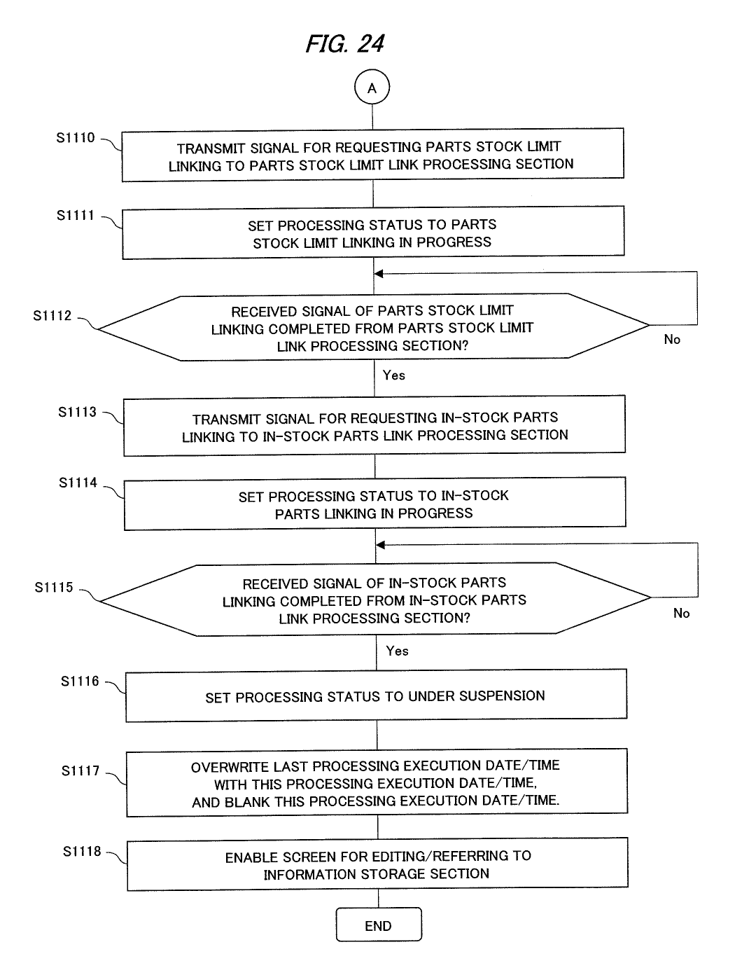

A figure for which FIG. 23 and FIG. 24 are connected by a connecting point A is one example of a processing flow relating to the plan generation procedure control processing section 1100.

In step S1101, the system 10 displays the menu screen of the maintenance parts inventory planning system.

Then, in step S1102, the system 10 waits, in the menu screen displayed in step S1101, for until a condition in which the selected processing division is the automatic execution and a system time is applicable to the specified start time pattern is fulfilled, and if said condition is fulfilled, proceeds to step S1103.

In step S1103, the system 10 disables the screen for editing/referring to the information storage section. Specifically, the system 10 sets to in use a machine status information storage section use flag, a machine status measurement information storage section use flag, a diagnostic criteria information storage section use flag, a failure risk information storage section use flag, an operating criteria information storage section use flag, a parts inventory frame link information storage section use flag, and an in-stock parts link information storage section use flag of a data structure on memory relating to the abovementioned menu screen, and disables a button for editing/referring to each information storage section on the menu screen.

Then, in step S1104, the system 10 overwrites this processing execution date/time with the system time. Then, in step S1105, the system 10 sets the processing status to a cumulative time calculation in progress.

Then, in step S1106, the system 10 obtains a future cumulative time. Specifically, the system 10 sets the following values for each calendar date in the future after this processing execution date/time, and stores the values in the machine status information storage section 1600. A machine operating rate of each machine is set to a value same as that of a machine operating rate on a calendar date immediately before this processing execution date/time. A machine cumulative operating time of each machine is set to a value for which a value for which a difference between said calendar date immediately before this processing execution date/time and each calendar date in the future after this processing execution date/time is multiplied by the machine operating rate of each machine is added to a machine cumulative operating time on the calendar date immediately before this processing execution date/time. A part cumulative usage time each part of each machine is a value for which a difference between said calendar date immediately before this processing execution date/time and each calendar date in the future after this processing execution date/time is multiplied by the machine operating rate of each machine is added to a part cumulative usage time of the calendar date immediately before this processing execution date/time.

Then, in step S1107, the system 10 transmits a signal for requesting a failure risk diagnosis to the failure risk diagnosis processing section 1200. Then, in step S1108, the system 10 sets the processing status to a failure risk diagnosis in progress.

Then, in step S1109, the system 10 waits for until a condition in which a signal of the failure risk diagnosis completed is received from the failure risk diagnosis processing section 1200 is fulfilled, and if said condition is fulfilled, proceeds to step S1110.

In step S1110, the system 10 transmits a signal for requesting linking of a parts inventory frame to the parts inventory frame link processing section 1300. Then, in step S1111, the system 10 sets the processing status to a parts inventory frame linking in progress.

Then, in step S1112, the system 10 waits for until a condition in which a signal of parts inventory frame linking completed is received from the parts inventory frame link processing section 1300 is fulfilled, and if said condition is fulfilled, proceeds to step S1113.

In step S1113, the system 10 transmits a signal for requesting in-stock parts linking to the in-stock parts link processing section 1400. Then, in step S1114, the system 10 sets the processing status to an in-stock parts linking in progress.

Then, in step S1115, the system 10 waits for until a condition in which a signal of in-stock parts linking completed is received from in-stock parts link processing section 1400 is fulfilled, and if said condition is fulfilled, proceeds to step S1116.

In step S1116, the system 10 sets the processing status to under suspension. Then, in step S1117, the system 10 overwrites the last processing execution date/time with this processing execution date/time, and blanks this processing execution date/time.

Then, in step S1118, the system 10 enables the screen for editing/referring to the information storage section. Specifically, the system 10 sets to not in use a machine status information storage section use flag, a machine status measurement information storage section use flag, a diagnostic criteria information storage section use flag, a failure risk information storage section use flag, an operating criteria information storage section use flag, a parts inventory frame link information storage section use flag, and an in-stock parts link information storage section use flag of a data structure on memory relating to the abovementioned menu screen, and enables a button for editing/referring to each information storage section on the menu screen.

<Processing Flow Relating to Failure Risk Diagnosis Processing Section>

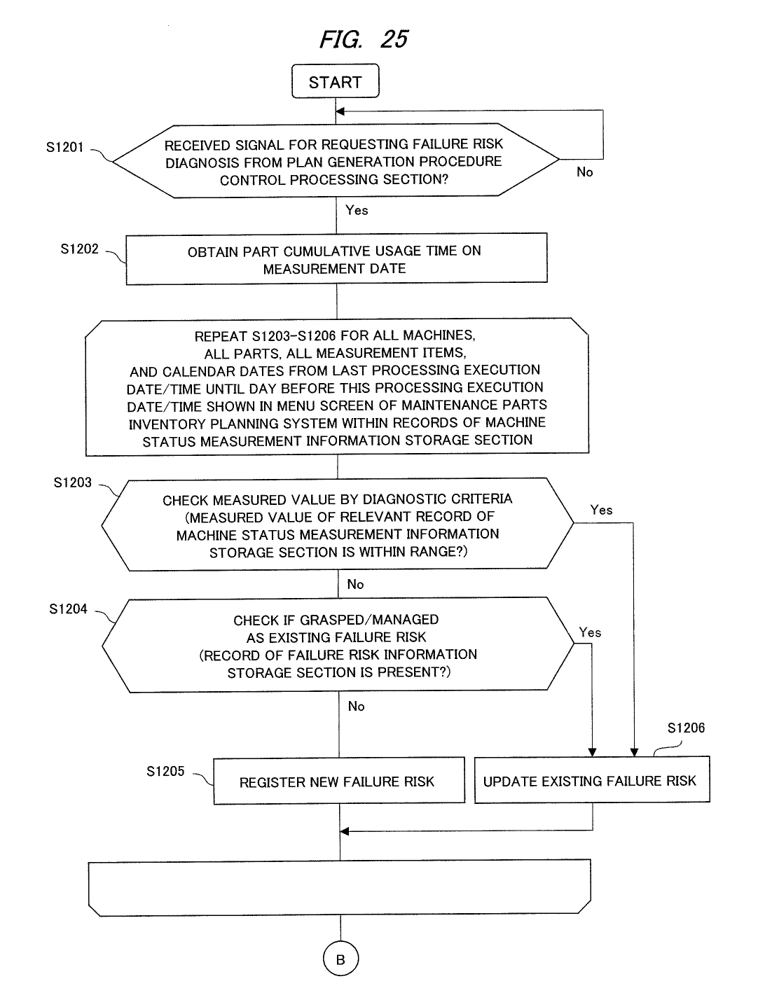

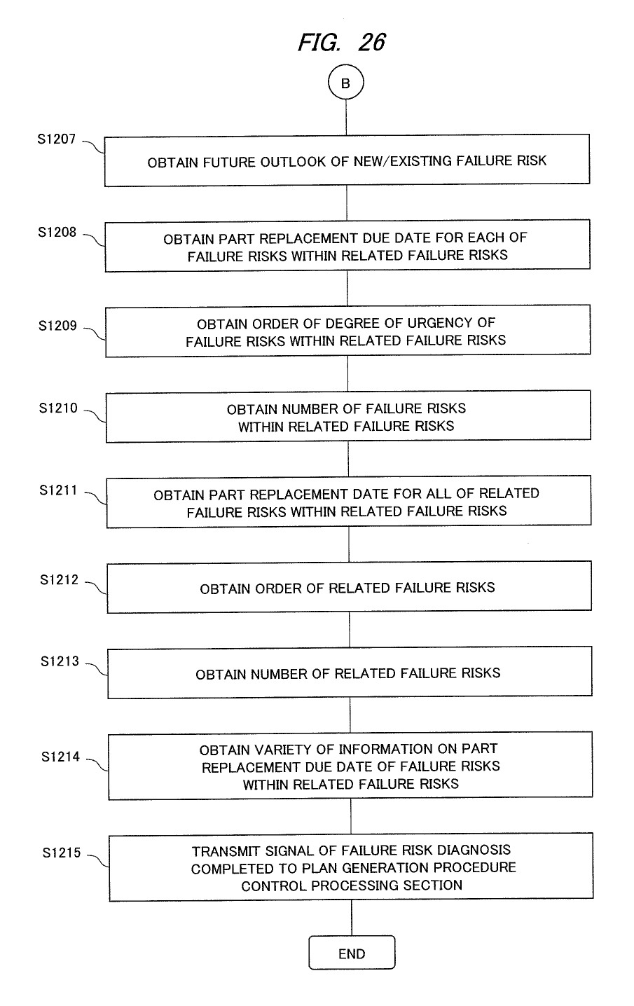

A figure for which FIG. 25 and FIG. 26 are connected by a connecting point B is one example of a processing flow relating to the failure risk diagnosis processing section 1200.

In step S1201, the system 10 waits for until a condition in which a signal for requesting a failure risk diagnosis is received from the plan generation procedure control processing section 1100 is fulfilled, and if said condition is fulfilled, proceeds to step S1202.

In step S1202, the system 10 obtains a part cumulative usage time on a measurement date. Specifically, within the records of the machine status measurement information storage section 1700, for a plurality of records for which each of all machines, all parts, all measurement items, calendar dates from the last processing execution date/time until the day before this processing execution date/time shown in the menu screen of the maintenance parts inventory planning system is used as a key, the following processings are performed. The system 10 writes, with each of all machines, all parts, calendar dates said last processing execution date/time until the day before said this processing execution date/time as a key, apart cumulative usage time of the machine status information storage section 1600 into a part cumulative usage time of said record of the machine status measurement information storage section 1700.

Then, within the records of the machine status measurement information storage section 1700, for all machines, all parts, all measurement items, and calendar dates from the last processing execution date/time until the day before this processing execution date/time shown in the menu screen of the maintenance parts inventory planning system, the system 10 repeats the processings from step S1203 to step S1206 in accordance with a branch condition.

In step S1203, the system 10 checks a measured value by diagnostic criteria. Specifically, if a condition, in which a measured value of said record of the machine status measurement information storage section 1700 is within a range of a measured value upper limit to a measured value lower limit of a record of the diagnostic criteria information storage section 1800 for which a part, a measurement item and a part cumulative usage time of said record of the machine status measurement information storage section 1700 are used as keys, is fulfilled, the system 10 proceeds to step S1206, and if said condition is not fulfilled, proceeds to step S1204.

In step S1204, the system 10 checks if a risk is grasped/managed as an existing failure risk. Specifically, if a condition in which a record of the failure risk information storage section 2000 containing a sign type of said record of the diagnostic criteria information storage section 1800 and a machine, a part, a measurement item and a calendar date of said record of the machine status measurement information storage section 1700 is present is fulfilled, the system proceeds to step S1206, and if said condition is not fulfilled, proceeds to step S1205.

In step S1205, the system 10 registers a new failure risk. Specifically, the system 10 newly generates a record for which a failure risk automatically newly assigned in the failure risk information storage section 2000 with an unique value and a calendar date of said record of the machine status measurement information storage section 1700 are used as keys, and performs the following write.

The system 10 writes the sign type of said record of the diagnostic criteria information storage section 1800 into a sign type of said record of the failure risk information storage section 2000. The system 10 writes, with the machine, part and calendar date of said record of the machine status measurement information storage section 1700 as keys, the machine cumulative operating time of the record of the machine status information storage section 1600, into the machine cumulative operating time (upon discovery) and the machine cumulative operating time of the failure risk information storage section 2000. The system 10 writes, the machine, part, measurement item, calendar date, part cumulative usage time and measured value of said record of the machine status measurement information storage section 1700, into the machine, part, measurement item and calendar date (upon discovery), and the calendar date and part cumulative usage time (upon discovery), and the part cumulative usage time and measured value (upon discovery), and the measured value of said record of the into failure risk information storage section 2000.

The system 10 writes, the sign type, measured value upper limit and measured value lower limit of said record of the diagnostic criteria information storage section 1800, into the sign type and measured value upper limit (upon discovery), and the measured value upper limit and measured value lower limit (upon discovery), and the measured value lower limit of said record of the failure risk information storage section 2000. The system 10 writes, with the part and part cumulative usage time of said record of the machine status measurement information storage section 1700 and the sign type of said record of the diagnostic criteria information storage section 1800 as keys, the parts failure probability of the record of the parts failure probability information storage section 1900, into the parts failure probability (upon discovery) and parts failure probability of said record of the failure risk information storage section 2000.

After step S1205, if there is a next repeating target, the system 10 returns to the repeating from step S1203, and if there is no next repeating target, proceeds to step S1207.

In step S1206, the system 10 updates an existing failure risk. Specifically, the system 10 performs the following write. The system 10 writes the calendar date of said record of the machine status measurement information storage section 1700 into the calendar date of the record of the failure risk information storage section 2000. The system 10 writes, with said calendar date, and the machine and part of said record of the failure risk information storage section 2000 as keys, the machine cumulative operating time of the record of the machine status information storage section 1600, into the machine cumulative operating time of said record of the failure risk information storage section 2000.

The system 10 writes, with said calendar date, the machine, part, and measurement item of said record of the failure risk information storage section 2000 as keys, the part cumulative usage time and measured value of the record of the machine status measurement information storage section 1700, into the part cumulative usage time and measured value of said record of the failure risk information storage section 2000. The system 10 writes, with the sign type, part and part cumulative usage time of said record of the failure risk information storage section 2000 as keys, the parts failure probability 1900 of the record of parts failure probability information storage section 1900, into the parts failure probability of said record of the failure risk information storage section 2000.

After step S1206, if there is a next repeating target, the system 10 returns to the repeating from step S1203, and if there is no next repeating target, proceeds to step S1207.

In step S1207, the system 10 obtains the future outlook of a new/existing failure risk. Specifically, within all of the records of the failure risk information storage section 2000, with regard to each of a plurality of records containing as a key a calendar date on and after this processing execution date/time shown in the menu screen of the maintenance parts inventory planning system, the system 10 performs the following write.

The system 10 writes, with the machine, part and calendar date of said record of the failure risk information storage section 2000 as keys, the machine cumulative operating time and the part cumulative usage time of the record of the machine status information storage section 1600, into the machine cumulative operating time and the part cumulative usage time of said record of the failure risk information storage section 2000. The system 10 writes, with the sign type, part and part cumulative usage time of said record of the failure risk information storage section 2000 as keys, the parts failure probability of the record of parts failure probability information storage section 1900, into the parts failure probability of said record of the failure risk information storage section 2000.

The system 10 writes, with a failure risk and a calendar date of the day before the calendar date of said record of the failure risk information storage section 2000 as keys, a measurement item of an another record of failure risk information storage section 2000, into the measurement item of said record of the failure risk information storage section 2000. The system 10 writes—into the measured value of said record of the failure risk information storage section 2000. The system 10 writes, with the part, measurement item and part cumulative usage time of said record of the failure risk information storage section 2000 as keys, the sign type, measured value upper limit and measured value lower limit of the diagnostic criteria information storage section 1800, into the sign type, measured value upper limit and measured value lower limit of said record of the failure risk information storage section 2000.

Then, in step S1208, the system 10 obtains a part replacement due date for each failure risk within the related failure risks. Specifically, for each of the plurality of collections (failure risks within the related failure risks) for which the records of the failure risk information storage section 2000 are divided into every identical machines, every identical parts, and every sign type, the system 10 performs the following write.

For the range in which the calendar date is on and after the last processing execution date/time shown in the menu screen of the maintenance parts inventory planning system, the system 10 writes, a total value of a part cumulative usage time for which a value of a part cumulative usage time (at the time of replacing a part) of the record of the operating criteria information storage section 2100 having a part and a sign type of said collections (failure risks within the related failure risks) as keys is added to a value of the part cumulative usage time (upon discovery) of said collections (failure risks within the related failure risks) of the failure risk information storage section 2000, into a calendar date (part replacement due date) of all of the records belonging to said collections (failure risks within the related failure risks) of the failure risk information storage section 2000. The system 10 writes, a calendar date of the record of machine status information storage section 1600 having the machine and part of said collections (failure risks within the related failure risks) of the failure risk information storage section 2000 as keys, into a calendar date (part replacement due date) of all of the records belonging to said collections (failure risks within the related failure risks) of the failure risk information storage section 2000.

Then, in step S1209, the system 10 obtains an order of a degree of urgency of the failure risks within the related failure risks. Specifically, for each of the plurality of collections (failure risks within the related failure risks) for which the records of the failure risk information storage section 2000 are divided into every identical machines, every identical parts, and every sign type, the system 10 performs the following write. For the range in which the calendar date is on and after the last processing execution date/time shown in the menu screen of the maintenance parts inventory planning system, the system 10 writes, an order of the calendar date (part replacement due date) of each of said collections (failure risks within the related failure risks), that is fixed in an order from an early date, into an order of failure risks within related failure risks of all of the records belonging to each of said collections (failure risks within the related failure risks).

Then, in step S1210, the system 10 obtains the number of the failure risks within the related failure risks. Specifically, for each of the plurality of collections (failure risks within the related failure risks) for which the records of the failure risk information storage section 2000 are divided into every identical machines, every identical parts, and every sign type, the system 10 performs the following write. For the range in which the calendar date is on and after the last processing execution date/time shown in the menu screen of the maintenance parts inventory planning system, the system 10 writes, a number of said collections (failure risks within the related failure risks), into a number of failure risk within the related failure risks of all of the records belonging to each of said collections (failure risks within the related failure risks).

Then, in step S1211, the system 10 obtains a part replacement date for all of the related failure risks within the related failure risks. Specifically, for each of the plurality of collections (failure risks within the related failure risks) for which the records of the failure risk information storage section 2000 are divided into every identical machines, every identical parts, and every sign type, the system 10 performs the following write. For the range in which the calendar date is on and after the last processing execution date/time shown in the menu screen of the maintenance parts inventory planning system, the system 10 writes, a calendar date (part replacement due date) of a failure risk that comes in the first place in the order of failure risks within related failure risks within said collections (failure risks within the related failure risks), into a part replacement calendar date of related failure risks of all of the records belonging to each of said collections (failure risks within the related failure risks).

Then, in step S1212, the system 10 obtains an order of the related failure risks. Specifically, for each of the plurality of collections (related failure risks) into which the records of the failure risk information storage section 2000 are divided for every identical machines and for every identical parts, the system 10 performs the following write. For the range in which the calendar date is on and after the last processing execution date/time shown in the menu screen of the maintenance parts inventory planning system, the system 10 writes, an order of a part replacement calendar date of the related failure risks of each of said collections (related failure risks) that is fixed in an order from an early date, into an order of the related failure risks of all of the records belonging to each of said collections (related failure risks).

Then, in step S1213, the system 10 obtains the number of the related failure risks. Specifically, for each of the plurality of collections (related failure risks) into which the records of the failure risk information storage section 2000 are divided for every identical machines and for every identical parts, the system 10 performs the following write. For the range in which the calendar date is on and after the last processing execution date/time shown in the menu screen of the maintenance parts inventory planning system, the system 10 writes the number of said collections (related failure risks) into the number of the related failure risks of all of the records belonging to each of said collections (related failure risks).

Then, in step S1214, the system 10 obtains a variety of information on a part replacement due date of the failure risks within the related failure risks. Specifically, for each of the plurality of collections (failure risks within the related failure risks) for which the records of the failure risk information storage section 2000 are divided into every identical machines, every identical parts, and every sign type, the system 10 performs the following write.

For the range in which the calendar date is on and after the last processing execution date/time shown in the menu screen of the maintenance parts inventory planning system, the system 10 writes, the machine cumulative operating time and the part cumulative usage time of the record of the machine status information storage section 1600 having the machine, part and calendar date (part replacement due date) of each of said collections (failure risks within the related failure risks) as keys, into the machine cumulative operating time (part replacement due date) and the part cumulative usage time (part replacement due date) of all of the records belonging to said collections (failure risks within the related failure risks). The system 10 writes, the parts failure probability of the record of parts failure probability information storage section 1900 having the sign type, part and part cumulative usage time (part replacement due date) of each of said collections (failure risks within the related failure risks) as keys, into the parts failure probability of all of the records belonging to each of said collections (failure risks within the related failure risks).

Then, in step S1215, the system 10 transmits a signal of the failure risk diagnosis completed to the plan generation procedure control processing section 1100.

<Processing Flow Relating to Parts Inventory Frame Link Processing Section>

A figure for which FIG. 27 and FIG. 28 are connected by a connecting point C is one example of a processing flow relating to the parts inventory frame link processing section 1300.

In step S1301, the system 10 waits for until a condition in which a signal for requesting parts inventory frame linking is received from the plan generation procedure control processing section 1100 is fulfilled, and if said condition is fulfilled, proceeds to a subsequent processing.

Then, for each of the plurality of collections (related failure risks) into which the records of the failure risk information storage section 2000 are divided for every identical machines and for every identical parts, for the range in which the calendar date is on and after the last processing execution date/time shown in the menu screen of the maintenance parts inventory planning system, the system 10 repeats the processings from step S1302 to step S1306 in accordance with a branch condition in the order from the highest of the order of the related failure risks of the said collections (related failure risks).

In step S1302, the system 10 searches for a parts inventory frame for which a failure risk is unlinked. Specifically, the system 10 obtains a calendar date by subtracting, a number of days of fixed period (part allocation-replacement) of the record of operating criteria information storage section 2100 having the part and sign type of said record of the failure risk information storage section 2000 as keys, from a calendar date (part replacement due date) of the record of the failure risk information storage section 2000, that comes in the first place in the order of failure risks within related failure risks within said collections (related failure risks). For a period from the obtained calendar date until the calendar date (part replacement due date) of said record of the failure risk information storage section 2000, the system searches for a parts inventory frame in which the parts inventory frame status of the record of the parts inventory frame link information storage section 2200 having the part and calendar date of said record of the failure risk information storage section 2000 as keys is unlinked over an entire said period.

Then, in step S1303, the system 10 proceeds to step S1304 if a condition in which, a parts inventory frame in which the parts inventory frame status of the record of the parts inventory frame link information storage section 2200 is unlinked over an entire said period is present, is fulfilled, and if said condition is not fulfilled, proceeds to step S1305.

In step S1304, the system 10 links a failure risk to a parts inventory frame. Specifically, for said period, the system 10 writes the failure risk of said record of the failure risk information storage section 2000 into the parts inventory frame status of said record of the parts inventory frame link information storage section 2200. After step S1304, if there is a next repeating target, the system 10 returns to the repeating from step S1302, and if there is no next repeating target, proceeds to step S1307.

In step S1305, the system 10 requests a parts inventory frame. Specifically, for on and after said period, the system 10 newly adds a record to the parts inventory frame link information storage section 2200, issues a unique number of a frame request and writes the same into a parts inventory frame of said added record, and writes unlinked into a parts inventory frame status of said added record.

Then, in step S1306, the system 10 links a failure risk to the frame request. Specifically, for said period, the system 10 writes the failure risk of said record of the failure risk information storage section 2000 into the parts inventory frame status of said added record of the parts inventory frame link information storage section 2200. After step S1306, if there is a next repeating target, the system 10 returns to the repeating from step S1302, and if there is no next repeating target, proceeds to step S1307.

In step S1307, the system 10 displays an initial screen of the screen for editing/referring to the parts inventory frame link information. Specifically, for the range in which the calendar date is on and after the last processing execution date/time shown in the menu screen of the maintenance parts inventory planning system, the system 10 refers to the record of the parts inventory frame link information storage section 2200, leaves an existent record information as it is, and replaces a parts inventory frame status of a nonexistent record with-. Furthermore, the system 10 displays the upper part of the screen for editing/referring to the parts inventory frame link information, and waits for an input from a user.

Then, in step S1308, the system 10 waits for until a condition in which an input from a user is present is fulfilled, and if said condition is fulfilled, proceeds to step S1309.

In step S1309, if a condition in which said input from the user is a mouse click for a column for displaying the parts inventory frame of the record of the parts inventory frame link information storage section 2200 is fulfilled, the system 10 proceeds to step S1310, and if said condition is not fulfilled, proceeds to step S1311.

In step S1310, the system 10 executes a processing corresponding to an operation for a parts inventory frame from a user. Specifically, the system 10 displays a submenu comprising response to frame request, add, delete and cancel, and performs the following processings.

When the user selects the response to frame request for said submenu, the system 10 issues, for a parts inventory frame for which a parts inventory frame status is in a status of a frame request, a unique number for the parts inventory frame, and overwrites the parts inventory frame of said record of the parts inventory frame information storage section with same, and for a period having the frame request, the system 10 writes the failure risk of said record of the failure risk information storage section 2000 into the parts inventory frame status of said record of the parts inventory frame link information storage section 2200.

When the user selects the add to frame request for said submenu, for the range of on and after last processing execution date/time, the system 10 issues a unique number for the parts inventory frame, registers a new record of the parts inventory frame information storage section, and writes unlinked into a parts inventory frame status of said record.

When the user selects the delete for said submenu, for the range of on and after last processing execution date/time, if and only if the parts inventory frame status of all of the records of the parts inventory frame information storage section relating to said parts inventory frame is unlinked, the system 10 deletes said all of the records of the parts inventory frame information storage section relating to said parts inventory frame. When the user selects the cancel for said submenu, said submenu is closed.

However, an edition reflection to the abovementioned various types of information storage sections is performed only if a reflect edition button is pushed down by a user, and if the reflect edition button is not pushed down by the user and a close button is pushed, the edition becomes invalid. After step S1310, the system 10 returns to step S1308.

In step S1311, if a condition in which said input from the user is a mouse click for a column showing the parts inventory frame status of the record of the parts inventory frame link information storage section 2200 is fulfilled, the system 10 proceeds to step S1312, and if said condition is not fulfilled, proceeds to step S1313.

In step S1312, the system 10 executes a processing corresponding to an operation for a parts inventory frame status from the user. Specifically, if a column showing a parts inventory frame status in the upper part of the screen for editing/referring to the parts inventory frame link information, that is selected by said mouse click, is neither unlinked nor-, and a failure risk is displayed, the system 10 displays, all of the information of the record of the failure risk information storage section 2000 having a calendar date at which the column of the parts inventory frame status showing said failure risk is located and said failure risk as keys, in the lower part of said screen for editing/referring to the parts inventory frame link information.

If there is a check in “also display failure risks other than the ranked 1st within the related failure risks”, the system 10 reads in information concerning a plurality of records of the failure risk information storage section 2000 with a related failure risk of a record of a failure risk the order within the related failure risks of which is the first place as a key. Furthermore, the system 10 displays all of the information of said plurality of records in an ascending order of the order within the related failure risks of said plurality of records in the lower part of said screen for editing/referring to the parts inventory frame link information. After step S1312, the system 10 returns to step S1308.

In step S1313, if a condition in which said input from the user is a mouse click for a close button is fulfilled, the system 10 proceeds to step S1314, and if said condition is not fulfilled, the system 10 returns to step S1308.

In step S1314, the system 10 closes the display of the screen for editing/referring to the parts inventory frame link information, and transmits a signal of parts inventory frame linking completed to the plan generation procedure control processing section 1100.

<Processing Flow Relating to in-Stock Parts Link Processing Section>

A figure for which FIG. 29 and FIG. 30 are connected by a connecting point D is one example of a processing flow relating to the in-stock parts link processing section 1400.

In step S1401, the system 10 waits for until a condition in which a signal for requesting in-stock parts linking is received from the plan generation procedure control processing section 1100 is fulfilled, and if said condition is fulfilled, proceeds to a subsequent processing.

Then, within the record of the parts inventory frame link information storage section 2200, for the range in which the calendar date is on and after the last processing execution date/time shown in the menu screen of the maintenance parts inventory planning system, the system 10 repeats the processings from step S1402 to step S1406 in accordance with a branch condition.

In step S1402, the system 10 searches for an in-stock part for which a parts inventory frame is unlinked. Specifically, for a period in which there are one or more of failure risks successively put in the parts inventory frame status of the record of the parts inventory frame link information storage section 2200, the system 10 searches for an in-stock part in which the in-stock part status of the record of the in-stock parts link information storage section 2300 having the part and calendar date of said record of the parts inventory frame link information storage section 2200 as keys is unlinked over an entire said period.

Then, in step S1403, if a condition in which an in-stock part in which the in-stock part status of the record of the in-stock parts link information storage section 2300 is unlinked over an entire said period is present is fulfilled, the system 10 proceeds to step S1404, and if said condition is not fulfilled, proceeds to step S1405.

In step S1404, the system 10 links a parts inventory frame to an in-stock part. Specifically, for said period, the system 10 writes the parts inventory frame of said record of the parts inventory frame link information storage section 2200 into the in-stock part status of said record of the in-stock parts link information storage section 2300. After step S1404, if there is a next repeating target, the system 10 returns to the repeating from step S1402, and if there is no next repeating target, proceeds to step S1407.

In step S1405, the system 10 requests an in-stock part. Specifically, for said period and after said period, the system 10 newly adds a record to the in-stock parts link information storage section 2300, issues a unique number of an in-stock part request and writes same into the in-stock part of said added record, and writes unlinked into the in-stock part status of said added record.

Then, in step S1406, the system 10 links a parts inventory frame to the in-stock part request. Specifically, for said period, the system 10 writes the parts inventory frame of said record of the parts inventory frame link information storage section 2200 into the in-stock part status of said added record of the in-stock parts link information storage section 2300. After step S1406, if there is a next repeating target, the system 10 returns to the repeating from step S1402, and if there is no next repeating target, proceeds to step S1407.

In step S1407, the system 10 displays an initial screen of the screen for editing/referring to the in-stock parts link information. Specifically, for the range in which the calendar date is on and after the last processing execution date/time shown in the menu screen of the maintenance parts inventory planning system, the system 10 refers to the record of the in-stock parts link information storage section 2300, leaves an existent record information as it is, and replaces a parts inventory frame status of a nonexistent record with-. Furthermore, the system 10 displays the upper part of the screen for editing/referring to the in-stock parts link information, and waits for an input from a user.

In step S1408, the system 10 waits for until a condition in which an input from a user is present is fulfilled, and if said condition is fulfilled, proceeds to step S1409.

In step S1409, if a condition in which said input from the user is a mouse click for a column for displaying the in-stock part of the record of the in-stock parts link information storage section 2300 is fulfilled, the system 10 proceeds to step S1410, and if said condition is not fulfilled, proceeds to step S1411.

In step S1410, the system 10 executes a processing corresponding to an operation for an in-stock part from the user. Specifically, the system 10 displays a submenu comprising response to in-stock part request, add, delete and cancel, and performs the following processings.

When the user selects the response to in-stock part request for said submenu, for an in-stock part for which an in-stock part status is in a status of an in-stock part request, the system receives an input of a number for uniquely identifying an in-stock part (manufacturer's part serial number, etc.) from a user, and for a period in which there is an in-stock part request, writes the parts inventory frame of said record of the parts inventory frame information storage section into the in-stock part status of said record of the in-stock parts information storage section.

When the user selects the add for said submenu, for the range of on and after last processing execution date/time, the system receives an input of a number for uniquely identifying said in-stock part (manufacturer's part serial number, etc.) from the user, and registers a new record of the in-stock parts information storage section, and writes unlinked into an in-stock part status of said record.

When the user selects the delete for said submenu, for the range of on and after last processing execution date/time, if and only if the in-stock part status of all of the records of the in-stock parts information storage section relating to said in-stock part is unlinked, the system 10 deletes said all of the records of the in-stock parts information storage section relating to said in-stock part. When the user selects the cancel for said submenu, said all of the records is deleted. When the user selects the cancel for said submenu, said submenu is closed.

However, an edition reflection to the abovementioned various types of information storage sections is performed only if a reflect edition button is pushed down by a user, and if the reflect edition button is not pushed down by the user and a close button is pushed, the edition becomes invalid. After step S1410, the system 10 returns to step S1408.

In step S1411, if a condition in which said input from the user is a mouse click for a column showing the in-stock part status of the record of the in-stock parts link information storage section 2300 is fulfilled, the system 10 proceeds to step S1412, and if said condition is not fulfilled, proceeds to step S1413.

In step S1412, the system 10 executes a processing corresponding to an operation for an in-stock part status from the user. Specifically, if a column showing an in-stock part status in the upper part of the screen for editing/referring to the in-stock parts link information, that is selected by said mouse click, is neither unlinked nor-, and a parts inventory frame is displayed, the system 10 performs the following display. The system 10 displays, all of the information of the record of the failure risk information storage section 2000 having as a key the failure risk written into the parts inventory frame status of the record of the parts inventory frame link information storage section 2200 having as keys the calendar date and part at which the column showing said in-stock part status is located and said parts inventory frame displayed in the column for showing said in-stock part status, in the lower part of said screen for editing/referring to the in-stock parts link information.

If there is a check in “also display failure risks other than the ranked 1st within the related failure risks”, the system 10 reads in information concerning a plurality of records of the failure risk information storage section 2000 with a related failure risk of a record of a failure risk the order within the related failure risks of which is the first place as a key. Furthermore, the system 10 displays all of the information of said plurality of records in an ascending order of the order within the related failure risks of said plurality of records in the lower part of said screen for editing/referring to the in-stock parts link information. After step S1412, the system 10 returns to step S1408.

In step S1413, if a condition in which said input from the user is a mouse click for a close button is fulfilled, the system 10 proceeds to step S1414, and if said condition is not fulfilled, the system 10 returns to step S1408.

In step S1414, the system 10 closes the display of the screen for editing/referring to the in-stock parts link information.

Then, in step S1415, the system 10 deletes all failure risks dissolved by actually replacing parts. Specifically, within the in-stock parts of the in-stock parts link information storage section 2300, if the record of the in-stock parts link information storage section 2300 relating to said in-stock part is not present on a calendar date from the last processing execution date/time until this processing execution date/time shown in the menu screen of the maintenance parts inventory planning system, the system performs the following delete. The system 10 deletes all of a parts inventory frame of the in-stock part status of the record of the in-stock parts information storage section on one day prior to said calendar date, the part of said record, a failure risk written into the parts inventory frame status of the record of the parts inventory frame link information storage section 2200 having said one day prior calendar date as a key, and the record of the failure risk information storage section 2000 having as a key the related failure risks of the record of the failure risk information storage section 2000 having said one day prior calendar date as a key.

Then, in step S1416, the system 10 transmits a signal of in-stock parts linking completed to the plan generation procedure control processing section 1100.

### Effect of this Embodiment

As stated above, according to this embodiment, as a maintenance parts inventory planning system 10, the system is provided with: the input reception processing section 1000; storing sections (the machine status information storage section 1600, machine status measurement information storage section 1700, diagnostic criteria information storage section 1800, parts failure probability information storage section 1900, failure risk information storage section 2000, operating criteria information storage section 2100, parts inventory frame link information storage section 2200 and in-stock parts link information storage section 2300); and plan generation sections (the plan generation procedure control processing section 1100, failure risk diagnosis processing section 1200, parts inventory frame link processing section 1300 and in-stock parts link processing section 1400); therefore, the following effect can be obtained.

That is, with such a configuration, the system can receive an input of information concerning an operating state of an industrial machine, a failure probability of a component, an inventory frame that is a theoretical inventory of a stored part, operating criteria indicating conditions at two points of time, a point of time of part allocation and a point of time of part replacement of a stored part, and an in-stock part, calculate a failure risk on the basis of the operating state of the industrial machine and the failure probability of the component, generate a maintenance parts inventory planning for linking a failure risk in the order from higher failure risk to an inventory frame that is a theoretical inventory of a stored part on a one-on-one basis in time series so as to fulfill the operating criteria indicating conditions at the two points of time, the point of time of stored part allocation and the point of time of part replacement of the stored part, and can further generate a maintenance in-stock parts planning for linking an inventory frame a part of said maintenance parts inventory planning to an in-stock part on a one-on-one basis.

In addition, by executing the generated maintenance parts inventory planning, omission of preparation for a failure risk constantly varying in the period of time is prevented, and a maintenance can be performed with a maintenance part inventory in just proportion, and thus it is possible to maintain and enhance the reliability of an industrial machine to be a maintenance target.

In addition, by displaying a failure risk linked to an inventory frame and an in-stock part of a part, in the unlikely event that there is a loss of or damage on an in-stock part, and that a warehouse and a production plant for providing an inventory frame of a part are closed due to a disaster, and the like, it can tell at a glance that to which failure risk there would be an influence, and thus delay in a countermeasure can be prevented.

As stated above, according to this embodiment, a stand-alone type maintenance parts inventory planning system 10, and a client-server type maintenance parts inventory planning system server 10a, client terminals 30/40 can be provided, in which omission of preparation for a failure risk is prevented, and a maintenance parts inventory planning having reasonableness, in which there is no stockout or overstock of a maintenance part is created, thereby improving practicability and economical efficiency of maintenance and providing a reliable industrial machine.

While the invention made by the present inventor has been specifically described above, the present invention is not limited to the abovementioned embodiment, and it goes without saying that various modifications can be made without departing from the scope thereof, and various variations are included.

For example, the abovementioned embodiment has been described in details in order to clearly explain the present invention, and is not necessarily limited to providing all of the configurations that have been described. The abovementioned embodiment illustrates a case wherein an input of information concerning an operating state of an industrial machine, a failure probability of a component, an inventory frame that is a theoretical inventory of a stored part, and operating criteria indicating conditions at two points of time, a point of time of part allocation and a point of time of part replacement of a stored part, and an in-stock part is received, however, is also applicable to the following case.

For example, in a case where an input of information concerning the operating state of the industrial machine, the failure probability of the component, and operating criteria indicating conditions at two points of time, a point of time of part allocation and a point of time of part replacement of a stored part is received, a failure risk on the basis of the operating state of the industrial machine and the failure probability of the component can be calculated, and a maintenance parts inventory planning indicating a time-series change in an inventory quantity of maintenance parts, for which the part replacement amount is subtracted from the part allocation amount of maintenance parts can be generated so as to fulfill the operating criteria indicating conditions at the two points of time, the point of time of part allocation and the point of time of part replacement of the stored part.

In addition, in a case where an input of information concerning an operating state of an industrial machine, a failure probability of a component, an inventory frame that is a theoretical inventory of a stored part and operating criteria indicating conditions at two points of time, a point of time of part allocation and a point of time of part replacement of a stored part is received, a failure risk on the basis of the operating state of the industrial machine and the failure probability of the component can be calculated, and a maintenance parts inventory planning for linking a failure risk in the order from higher failure risk to an inventory frame that is a theoretical inventory of a stored part on a one-on-one basis in time series can be generated so as to fulfill the operating criteria indicating conditions at the two points of time, the point of time of part allocation and a point of time of part replacement of the stored part.

In addition, in the abovementioned embodiment, a part of a configuration can be replaced with other configuration, and other configuration can also be added to the configuration. In addition, to a part of each configuration, addition/deletion/replacement of other configuration can be performed.

In addition, the abovementioned each configuration, function, processing section and processing mean and the like may be implemented by hardware by designing or the like, a part or whole of those by, for example, an integrated circuit. In addition, the abovementioned each configuration, function and the like may be implemented by software by a processor interpreting a program that implements each function and executing same. Information such as the program that implements each function, table, file and the like may be placed in a recording device such as memory, hard disk and SSD (Solid State Drive), or in a recording medium such as IC card, SD card, and DVD.

In addition, a control line and an information line which are considered necessary for explanation are illustrated, and not all of control lines and information lines have been necessarily illustrated in terms of a product. It may be considered that almost all configurations are interconnected in a practical sense.

### INDUSTRIAL APPLICABILITY

The maintenance parts inventory planning system of the present invention is applicable to a stand-alone type maintenance parts inventory planning system, and further to a client-server type maintenance parts inventory planning system server and a maintenance parts inventory planning system client terminal.

### EXPLANATION OF REFERENCE NUMERALS

10 Maintenance parts inventory planning system
10a Maintenance parts inventory planning system server
1000 Input reception processing section
1100 Plan generation procedure control processing section
1200 Failure risk diagnosis processing section
1300 Parts inventory frame link processing section
1400 In-stock parts link processing section
1500 Output processing section
1600 Machine status information storage section
1700 Machine status measurement information storage section
1800 Diagnostic criteria information storage section
1900 Parts failure probability information storage section
2000 Failure risk information storage section
2100 Operating criteria information storage section
2200 Parts inventory frame link information storage section
2300 In-stock parts link information storage section
20 Network
30, 40 Client terminal
3100, 4100 Input reception processing section
3500, 4500 Output processing section

What is claimed is:

1. A maintenance parts inventory planning system which creates a maintenance parts inventory planning of one or more industrial machines by computer, comprising:
an input reception processing section which receives an input of information concerning an operating state of an industrial machine, a failure probability of a component, operating criteria indicating conditions at two points of time, a point of time of part allocation and a point of time of part replacement of a stored part;
storing sections which store information input from the input reception processing section; and
plan generation sections which calculate a failure risk on the basis of the operating state of the industrial machine and the failure probability of the component that are stored in the storing sections, store this calculated failure risk in the storing sections, generate a maintenance parts inventory planning indicating a time-series change in an inventory quantity of maintenance parts, for which a part replacement amount is subtracted from a part allocation amount of maintenance parts so as to fulfill the operating criteria stored in the storing sections, that indicate the conditions at the two points of time, the point of time of part allocation and the point of time of part replacement of the stored part, and store this generated maintenance parts inventory planning in the storing sections.

2. The maintenance parts inventory planning system according to claim 1,
wherein the input reception processing section further receives, in addition to the information concerning the operating state of the industrial machine, the failure probability of the component, and the operating criteria indicating the conditions at the two points of time, the point of time of part allocation and the point of time of part replacement of the stored part, an input of information concerning an inventory frame that is a theoretical inventory of a stored part,
the storing sections store the information input from the input reception processing section,
the plan generation sections calculate a failure risk on the basis of the operating state of the industrial machine and the failure probability of the component that are stored in the storing sections, store this calculated failure risk in the storing sections, generate a maintenance parts inventory planning for linking a failure risk in the order from higher failure risk to an inventory frame that is the theoretical inventory of the stored part on a one-on-one basis in time series so as to fulfill the operating criteria stored in the storing sections, that indicate conditions at two points of time, the point of time of part allocation and the point of time of part replacement of the stored part, and store this generated maintenance parts inventory planning in the storing sections.

3. The maintenance parts inventory planning system according to claim 2,
wherein the input reception processing section further receives an input of information concerning an in-stock part,
the plan generation sections further generate a maintenance in-stock parts planning in which the in-stock part is linked to the inventory frame on a one-on-one basis in time series in the maintenance parts inventory planning stored in the storing sections, and store this generated maintenance in-stock parts planning in the storing sections.

4. The maintenance parts inventory planning system according to claim 2, comprising a server and a client terminal,
wherein the input reception processing section is provided in the client terminal,
the storing sections and the plan generation sections are provided in the server, and
the server and the client terminal are connected to each other through a network.

5. The maintenance parts inventory planning system according to claim 2, comprising: an output section that outputs a display screen for input and output,
wherein the display screen comprises:
a screen for inputting information concerning the operating state of the industrial machine, the failure probability of the component, the inventory frame that is the theoretical inventory of the stored part and operating criteria indicating conditions at the two points of time, the point of time of part allocation and the point of time of part replacement of the stored part; and
a screen for displaying the maintenance parts inventory planning generated in the plan generation section and the failure risk stored in the storing sections.

6. The maintenance parts inventory planning system according to claim 2,
wherein when operating criteria indicating conditions at the two points of time, the point of time of part allocation and the point of time of part replacement of the stored part are input, a parts failure probability and a part cumulative usage time at the time of part replacement are input as an operating criteria at the time of part replacement, and a fixed period from the time of part allocation until the time of part replacement is input as an operating criteria at the time of part allocation.

7. A maintenance parts inventory planning system server for creating a maintenance parts inventory planning of one or more industrial machines, the system comprising:
storing sections which store information input from a client terminal that receives an input of information concerning an operating state of an industrial machine, a failure probability of a component, an inventory frame that is a theoretical inventory of a stored part and operating criteria indicating conditions at two points of time, a point of time of part allocation and a point of time of part replacement of a stored part; and
plan generation sections which calculate a failure risk on the basis of the operating state of the industrial machine and the failure probability of the component, that are stored in the storing sections, store this calculated failure risk in the storing sections, generate a maintenance parts inventory planning for linking a failure risk in the order from higher failure risk to an inventory frame that is a theoretical inventory of the stored part on a one-on-one basis in time series so as to fulfill the operating criteria at the time of part allocation and at the time of part replacement of the stored part, that are stored in the storing sections, and store this generated maintenance parts inventory planning in the storing sections.

8. The maintenance parts inventory planning system server according to claim 7,
wherein the client terminal further receives an input of information concerning an in-stock part, and
the plan generation sections further generate, in the maintenance parts inventory planning stored in the storing sections, a maintenance in-stock parts planning in which the in-stock part is linked to the inventory frame on a one-on-one basis in time series, and store this generated maintenance in-stock parts planning in the storing sections.

9. A maintenance parts inventory planning system client terminal which inputs/outputs information to/from a maintenance parts inventory planning system server that creates a maintenance parts inventory planning of one or more industrial machines, the system comprising:
an input reception processing section that receives input concerning an operating state of an industrial machine, a failure probability of a component, an inventory frame that is a theoretical inventory of a stored part and operating criteria indicating conditions at two points of time, a point of time of part allocation and a point of time of part replacement of a stored part; and
an output processing section that outputs information from the maintenance parts inventory planning system server,
wherein the maintenance parts inventory planning system server calculates a failure risk on the basis of the operating state of the industrial machine and the failure probability of the component input from the input reception processing section, and transmits, a maintenance parts inventory planning generated in such a manner that a failure risk is linked to the inventory frame that is the theoretical inventory of the stored part in the order from higher failure risk on a one-on-one basis in time series so as to fulfill the operating criteria indicating conditions at two points of time, the point of time of stored part allocation and the point of time of part replacement of the stored part, to the maintenance parts inventory planning system client terminal, and
wherein the output processing section outputs the maintenance parts inventory planning transmitted from the maintenance parts inventory planning system server.

10. The maintenance parts inventory planning system client terminal according to claim 9,
wherein the input reception processing section further receives an input of information concerning an in-stock part, and
the maintenance parts inventory planning system server further generates, in the maintenance parts inventory planning, a maintenance in-stock parts planning in which the in-stock part is linked to the inventory frame on a one-on-one basis in time series, and the output processing section outputs this generated maintenance in-stock parts planning.
